(19) United States
(12) Patent Application Publication
(10) Pub. No.: US 2026/0204792 A1
(43) Pub. Date: Jul. 16, 2026

(54) ELECTRONIC DEVICE

(71) Applicant: HUAWEI TECHNOLOGIES CO., LTD., Shenzhen (CN)

(72) Inventors: Xiaolu Zhang, Xi'an (CN); Mao Ye, Xi'an (CN); Meng Wei, Xi'an (CN); Chengcheng Nie, Xi'an (CN); Chen Zhang, Xi'an (CN); Yundi Yao, Dongguan (CN); Ruiyang Li, Shenzhen (CN)

(73) Assignee: HUAWEI TECHNOLOGIES CO., LTD., Shenzhen (CN)

(21) Appl. No.: 19/563,788

(22) Filed: Mar. 11, 2026

Related U.S. Application Data
(63) Continuation of application No. PCT/CN2024/104293, filed on Jul. 8, 2024.

(30) Foreign Application Priority Data
Sep. 27, 2023 (CN) 202311290660.3
Jul. 4, 2024 (CN) 202410898155.5

(51) Int. Cl. H01Q 13/10; H01Q 1/38; H01Q 1/48; H01Q 21/28; H01Q 25/04

(52) U.S. Cl. CPC H01Q 13/106; H01Q 1/38; H01Q 1/48; H01Q 21/28; H01Q 25/04

(57) ABSTRACT

An electronic device includes an outer casing and an antenna structure located in the outer casing. The antenna structure includes a circuit board and a first radiation structure including a first radiation ring and a plurality of stubs. The outer casing includes a metal ring housing extending in an axial direction, which is parallel to the axial direction of the first radiation ring. The plurality of stubs, including one feed stub and at least two first grounding stubs, are distributed in a circumferential direction of the first radiation ring and are connected between the first radiation ring and the circuit board. Two adjacent stubs and a first section of the first radiation ring that is located between the two adjacent stubs form an antenna substructure. The feed stub is configured to feed the first radiation ring that is configured to generate a first resonance.

### CROSS-REFERENCE TO RELATED APPLICATIONS

This application is a continuation of International Application No. PCT/CN2024/104293, filed on Jul. 8, 2024, which claims priorities to Chinese Patent Application No. 202311290660.3, filed on Sep. 27, 2023, and Chinese Patent Application No. 202410898155.5, filed on Jul. 4, 2024. All of the aforementioned patent applications are hereby incorporated by reference in their entireties.

### TECHNICAL FIELD

This application relates to the field of communication technologies, and in particular, to electronic devices.

### BACKGROUND

With continuous development of communication technologies, as a basic application of an internet of things (IoT) technology, a smart home system is widely promoted in scenarios such as life, entertainment, learning, and office. In a smart home scenario, an IoT application client may be installed on an electronic device used by a user, or an electronic device may support binding to a user account of an IoT application. The user may control a terminal device through the IoT application, to implement intelligent association between the electronic device used by the user and the terminal device. For example, the user may deliver, to a smart light through an IoT application of a remote control apparatus, an instruction for changing a light scenario, to control the smart light to adjust light.

A wireless connection technology, for example, wireless fidelity (Wi-Fi), Bluetooth, or Zig-bee, is usually used for a connection between the electronic device and the IoT application. An electronic device supporting a Wi-Fi protocol may be connected to the internet according to an Internet protocol (IP), to access an IoT smart home platform. The IoT smart home platform may interact with the IoT application client installed on the electronic device used by the user, to implement interaction between the electronic device and the IoT application.

Currently, based on different preferences of users, outer casings of electronic devices may be made of different materials, to reflect different textures. However, for an electronic device with a metal outer casing, the metal outer casing adversely affects an antenna inside the electronic device, and consequently, radiation efficiency and a pattern of the antenna deteriorate.

### SUMMARY

This application provides an electronic device, to implement a high-efficiency omnidirectional radiation mode of an antenna structure, thereby improving radiation efficiency and directivity of the antenna structure in a metal ring housing.

According to a first aspect, this application provides an electronic device. The electronic device includes an outer casing and an antenna structure, and the antenna structure is located in the outer casing. The outer casing includes a metal ring housing, and the metal ring housing extends in an axial direction. The antenna structure includes a circuit board and a first radiation structure disposed on a side of the circuit board. The first radiation structure includes a first radiation ring and a plurality of stubs, an axial direction of the first radiation ring is disposed at an included angle with the circuit board, the axial direction of the first radiation ring is parallel to the axial direction of the metal ring housing, the plurality of stubs are disposed between the first radiation ring and the circuit board in a circumferential direction of the first radiation ring and are electrically connected to the first radiation ring and the circuit board, the plurality of stubs include one feed stub and at least two first grounding stubs, the feed stub is electrically connected to a signal layer of the circuit board and is configured to feed the first radiation ring, and the at least two first grounding stubs are electrically connected to a grounding plane of the circuit board and are used for grounding. Any two adjacent stubs divide the first radiation ring into a first section and a second section, a length of the second section in the circumferential direction of the first radiation ring is greater than a length of the first section in the circumferential direction of the first radiation ring, the first radiation structure includes a plurality of first antenna substructures, the plurality of first antenna substructures are configured to generate first resonance, and each first antenna substructure includes two adjacent stubs and a first section that is of the first radiation ring and that is located between the foregoing two adjacent stubs.

When the antenna structure of the electronic device performs communication, the first radiation structure may generate the first resonance. Therefore, in a first resonance mode, the first radiation structure may be equivalent to the plurality of first antenna substructures operating together, to implement a high-efficiency omnidirectional radiation mode of the antenna structure, thereby improving radiation efficiency and directivity of the antenna structure in the metal ring housing.

In an embodiment, the first radiation ring is at a first distance from the circuit board, on a side that is of the circuit board and that faces the first radiation structure, there is a second distance between the circuit board and an end that is of the metal ring housing and that is away from the circuit board, the second distance is greater than the first distance, the second distance is less than or equal to 0.22λ, and λ is a free space wavelength corresponding to a resonance point frequency of the first resonance.

The first radiation ring includes a plurality of first sections, and lengths of these first sections in the circumferential direction of the first radiation ring are equal, so that the plurality of stubs are evenly disposed in the circumferential direction of the first radiation ring. Alternatively, the plurality of stubs may be unevenly distributed in the circumferential direction of the first radiation ring. This is not limited herein. In this embodiment, dimensions of the plurality of stubs may be equal, so that dimensions of the plurality of first antenna substructures of the first radiation structure are equal.

In the foregoing embodiment, a length of the first section that is of the first radiation ring and that is located between the two adjacent stubs is d1, lengths of the two stubs adjacent to the first section are respectively d2 and d3, and a sum of d1, d2, and d3 is in a range of (0.5±0.125)λ. In the first resonance mode, each first antenna substructure has same current distribution, so that the mode has good horizontal-plane coverage.

In the electronic device, the at least two first grounding stubs are not electrically connected to the grounding plane of the circuit board through an inductive component or a winding inductor.

In an embodiment, current distribution of the first radiation structure for generating the first resonance includes first co-directional current distribution on the two adjacent stubs and first reverse current distribution on the first section that is of the first radiation ring and that is located between the two adjacent stubs, and the first reverse current distribution has one current reverse point.

In an embodiment, between two adjacent stubs, the first radiation ring has a slot or a slit, and the slot or the slit is located in a middle area of the first section.

During actual application, according to a dual-band or multi-band scenario requirement, the antenna structure may be configured to generate a plurality of operating modes. For example, in an embodiment, the first radiation ring may be further configured to generate second resonance. A resonance point frequency of the second resonance is higher than the resonance point frequency of the first resonance. Current distribution of the first radiation ring for generating the second resonance includes second reverse current distribution on the first radiation ring, and the second reverse current distribution has two current reverse points.

In the electronic device, the first radiation ring may be further configured to generate third resonance. A resonance point frequency of the third resonance is higher than the resonance point frequency of the second resonance. In an embodiment, current distribution of the first radiation ring for generating the third resonance includes third reverse current distribution on the first radiation ring, and the third reverse current distribution has four current reverse points.

In addition to resonance generated by the first radiation structure, the antenna structure may further include a second radiation structure, to generate other resonance. The second radiation structure includes a second radiation ring and at least two second grounding stubs. In an embodiment, an axial direction of the second radiation ring is parallel to the axial direction of the first radiation ring, and a minimum inner diameter of the second radiation ring is greater than a maximum outer diameter of the first radiation ring. The at least two second grounding stubs are disposed between the second radiation ring and the circuit board in a circumferential direction of the second radiation ring and are electrically connected to the second radiation ring and the circuit board. Any two adjacent second grounding stubs divide the second radiation ring into a third section and a fourth section, a length of the fourth section in the circumferential direction of the second radiation ring is greater than a length of the third section in the circumferential direction of the second radiation ring, the second radiation structure includes a plurality of second antenna substructures, the plurality of second antenna substructures are configured to generate fourth resonance, and each second antenna substructure includes two adjacent second grounding stubs and a third section that is of the second radiation ring and that is located between the foregoing two adjacent second grounding stubs. In the antenna structure, the second radiation structure is configured to generate the fourth resonance, and two adjacent second grounding stubs and a third section that is of the second radiation ring and that is located between the two adjacent second grounding stubs form the second antenna substructure. When the second radiation structure operates, the second radiation structure may be equivalent to the plurality of second antenna substructures operating together, to further improve radiation efficiency and directivity of the antenna structure in the metal ring housing.

In an embodiment, the second radiation ring includes a plurality of third sections, and lengths of these third sections in the circumferential direction of the second radiation ring are equal. Alternatively, the plurality of second grounding stubs may be unevenly distributed in the circumferential direction of the second radiation ring. This is not limited herein. In addition, dimensions of the at least two second grounding stubs may be equal, so that dimensions of the plurality of second antenna substructures of the second radiation structure are equal.

In an embodiment, the current distribution of the second radiation structure for generating the fourth resonance includes second co-directional current distribution on the two adjacent second grounding stubs and fourth reverse current distribution on the third section that is of the second radiation ring and that is located between the two adjacent second grounding stubs, and the fourth reverse current distribution has one current reverse point.

In an embodiment, the first radiation ring is at the first distance from the circuit board, the second radiation ring at a third distance from the circuit board, and the third distance is greater than zero and less than the first distance. In other words, by using the circuit board as a reference, a height of the first radiation ring is higher than a height of the second radiation ring, so that the first radiation ring has high-efficiency radiation.

Extension directions of the plurality of stubs of the first radiation structure may be disposed at included angles with a perpendicular direction of the circuit board, and the included angle is less than or equal to 45 degrees.

In an embodiment, there is an equal included angle between an extension direction of each stub and the perpendicular direction of the circuit board, and the plurality of stubs may be disposed in sequence, so that dimensions of the stubs are the same, and a manufacturing process of the antenna structure is simplified.

In addition, a shape of the first radiation ring may include a circular ring, a triangle, a rectangle, or another polygon. This is not limited in this application.

In an embodiment, there is a fourth distance between the first radiation ring and the metal ring housing in a circumferential direction of the metal ring housing, and the fourth distance is greater than or equal to 0.024λ. In this way, the electronic device can maintain better antenna efficiency.

In the electronic device in this application, the metal ring housing may be electrically connected to the grounding plane of the circuit board through a metal member and is used for grounding.

In an embodiment, the electronic device may further include a first cover plate and a second cover plate. The first cover plate and the second cover plate are respectively disposed at two ends of the metal ring housing, and enclose an accommodation cavity together with the metal ring housing. The antenna structure is disposed in the accommodation cavity.

In an embodiment, the first radiation structure is disposed between the circuit board and the first cover plate. The first cover plate may be used as a display surface of the electronic device. In an embodiment, the first cover plate has a conductive area, and there is an insulation gap between the conductive area and the metal ring housing. To avoid impact of the metal ring housing on a function of the conductive area, the insulation gap may be set to be greater than or equal to 0.02λ.

According to a second aspect, this application provides an electronic device. The electronic device includes an outer casing and an antenna structure, and the antenna structure is located in the outer casing. The antenna structure includes a first radiator, a second radiator, and at least two stubs. In an embodiment, the first radiator and the second radiator are the same and symmetrically disposed. The at least two stubs are connected between the first radiator and the second radiator. The antenna structure further includes a feed point. In the antenna structure, the feed point may be located on one of the at least two stubs, or the feed point may be located on the first radiator and disposed close to one of the at least two stubs. Any two adjacent stubs of the at least two stubs may divide the first radiator into a first section and a second section and divide the second radiator into a third section and a fourth section, a length of the second section in a circumferential direction of the first radiator is greater than or equal to a length of the first section in the circumferential direction of the first radiator, and a length of the fourth section in a circumferential direction of the second radiator is greater than or equal to a length of the third section in the circumferential direction of the second radiator. The antenna structure includes a plurality of antenna substructures, the foregoing plurality of antenna substructures may be configured to generate sixth resonance, each antenna substructure includes any two adjacent stubs, and a first section and a third section that are located between the any two adjacent stubs.

In the electronic device in this application, the sixth resonance may be generated when the antenna structure performs communication. In a sixth resonance mode, a current on the first radiator and a current on the second radiator cancel each other, the antenna structure performs radiation in a vertical polarization manner through the at least two stubs, and the antenna structure may be equivalent to the plurality of antenna substructures operating together, to implement an omnidirectional radiation mode of the antenna structure, thereby implementing 360-degree horizontal-plane omnidirectional coverage of the electronic device.

The electronic device in this application may be used in a vehicle. In an embodiment, the electronic device may be an in-vehicle infotainment system (telematics box, TBox), and is configured to communicate with a mobile phone, a background system, a base station, or the like, to display and control vehicle information. The electronic device may be mounted on a vehicle, and may be located on the top of the vehicle, in a cabin, or in an engine compartment. In another embodiment, the electronic device may be a vehicle key, so that an operation performed by the vehicle key on the vehicle can be implemented at any orientation of the vehicle.

In an embodiment, in each antenna substructure, a sum of a length of the first section, a length of the third section, and lengths of the two stubs is in a range of (0.8±0.25)λ, to further improve omnidirectional radiation performance of the antenna structure. λ is a free space wavelength corresponding to a resonance point frequency of the sixth resonance. In other words, a sum of a half of the length of the first section, a half of the length of the third section, and a length of a stub connected between the first section and the third section is in a range of (0.4±0.125)λ.

In the electronic device of this application, the first radiator and the second radiator have a same shape. In an embodiment, the first radiator and the second radiator may be ring radiators, for example, the shape may include a triangle, a circle, a square, or another polygon. In an embodiment, the first radiator and the second radiator are respectively radiation rings. The at least two stubs are disposed at equal distances in a circumferential direction of the radiation rings, and dimensions of the at least two stubs are equal. Certainly, the first radiator and the second radiator may alternatively be in other shapes. In another embodiment, the first radiator is used as an example. The first radiator includes at least three radiation stubs. Ends of all of these radiation stubs are converged into one point and connected, the other ends of all of these radiation stubs extend in directions away from the point, and the other ends of these radiation stubs are arranged in an axial direction.

In addition, when a length dimension of each antenna substructure is λ, a length of each stub may be greater than the length of the first section, so that the antenna structure is of a slender structure. In this way, a width dimension of the antenna structure is reduced. Alternatively, a length of each stub may be less than the length of the first section, so that the antenna structure is of a short and stout structure. In this way, a height dimension of the antenna structure is reduced.

In this application, current distribution of the antenna structure for generating the sixth resonance includes first co-directional current distribution on the any two adjacent stubs, first reverse current distribution on the first section, and second reverse current distribution on the third section, and the first reverse current distribution and the second reverse current distribution each have one current reverse point.

In an embodiment, between two adjacent stubs, the first radiator has a slot or a slit, and the slot or the slit of the first radiator is located at the current reverse point of the first section; and/or the second radiator has a slot or a slit, and the slot or the slit of the second radiator is located at the current reverse point of the third section.

### BRIEF DESCRIPTION OF DRAWINGS

FIG. 1 is a diagram of a structure of an electronic device according to an embodiment of this application;

FIG. 2 is a diagram of a structure of an antenna structure according to an embodiment of this application;

FIG. 3 is a diagram of current distribution of a first radiation structure in FIG. 2 in a first resonance mode;

FIG. 4 is a 3D pattern of a fundamental mode f1 of the antenna structure in FIG. 3;

FIG. 5 is a horizontal-plane pattern of a fundamental mode f1 of the antenna structure in FIG. 3;

FIG. 6 is a diagram of another structure of an electronic device according to an embodiment of this application;

FIG. 7 is a diagram of current distribution of a first radiation structure in FIG. 1 in a second resonance mode;

FIG. 8 is a 3D pattern of a mode f2 of an antenna structure in FIG. 7;

FIG. 9 is a horizontal-plane pattern of a mode f2 of an antenna structure in FIG. 7;

FIG. 10 is a diagram of current distribution obtained after a first grounding stub is removed from the first radiation structure in FIG. 7;

FIG. 11 is a diagram of current distribution of a first radiation structure in FIG. 1 in a third resonance mode;

FIG. 12 is a 3D pattern of a mode f3 of an antenna structure in FIG. 11;

FIG. 13 is a horizontal-plane pattern of a mode f3 of an antenna structure in FIG. 11;

FIG. 14 is a diagram of current distribution obtained after a first grounding stub is removed from the first radiation structure in FIG. 11;

FIG. 15 is a diagram of another structure of an antenna structure according to an embodiment of this application;

FIG. 16 is a side view of the antenna structure in FIG. 15;

FIG. 17 is a diagram of current distribution of a second radiation structure in the antenna structure in FIG. 15 in a fourth resonance mode;

FIG. 18 is a diagram of other current distribution of a second radiation structure in FIG. 15 in a fourth resonance mode;

FIG. 19 is a 3D pattern of a mode f4 of the antenna structure in FIG. 18;

FIG. 20 is a horizontal-plane pattern of a mode f4 of the antenna structure in FIG. 18;

FIG. 21 is a diagram of another structure of an electronic device according to an embodiment of this application;

FIG. 22 is a diagram of another structure of an electronic device according to an embodiment of this application;

FIG. 23 is a diagram of another structure of an electronic device according to an embodiment of this application;

FIG. 24 is a diagram of S11 of the electronic device in FIG. 21;

FIG. 25 is a diagram of efficiency of the electronic device in FIG. 21;

FIG. 26 is a diagram of comparison between resonance frequencies of antenna structures in FIG. 15 with different quantities of stubs;

FIG. 27 is a diagram of comparison between radiation efficiency of antenna structures in FIG. 15 with different quantities of stubs;

FIG. 28 is a diagram of another structure of an antenna structure according to an embodiment of this application;

FIG. 29 is a diagram of comparison between S11 of antenna structures in FIG. 28 with slits of different widths;

FIG. 30 is a diagram of comparison between efficiency of antenna structures in FIG. 28 with slits of different widths;

FIG. 31 is a diagram of a first radiation ring according to an embodiment of this application;

FIG. 32 is another diagram of an electronic device according to an embodiment of this application;

FIG. 33 is another diagram of an antenna structure according to an embodiment of this application;

FIG. 34 is a diagram of current distribution of a first radiation structure in FIG. 33 in a first resonance mode;

FIG. 35 is a diagram of current distribution of a first radiation structure in FIG. 33 in a second resonance mode;

FIG. 36 is a diagram of current distribution of a first radiation structure in FIG. 33 in a third resonance mode;

FIG. 37 is a diagram of current distribution of a first radiation structure in FIG. 33 in a fourth resonance mode;

FIG. 38 is a diagram of current distribution of a first radiation structure in FIG. 33 in a fifth resonance mode;

FIG. 39 is a diagram of S11 of the antenna structure in FIG. 33 in a first resonance mode, a second resonance mode, a third resonance mode, a fourth resonance mode, and a fifth resonance mode;

FIG. 40 is a diagram of another structure of an antenna structure according to an embodiment of this application;

FIG. 41 is a diagram of current distribution of the antenna structure 12 in FIG. 40 in a sixth resonance mode;

FIG. 42 is a 3D pattern of the antenna structure in FIG. 40 in a sixth resonance mode;

FIG. 43 is a diagram of S11 of the antenna structure in FIG. 40;

FIG. 44 is a diagram of efficiency of the antenna structure in FIG. 40;

FIG. 45 is a diagram of another structure of an antenna structure according to an embodiment of this application;

FIG. 46 is a diagram of current distribution of the antenna structure in FIG. 45 in a sixth resonance mode;

FIG. 47 is an E-plane pattern of the antenna structure in FIG. 45;

FIG. 48 is an H-plane pattern of the antenna structure in FIG. 45;

FIG. 49 is a diagram of another structure of an antenna structure according to an embodiment of this application;

FIG. 50 is a diagram of current distribution of the antenna structure in FIG. 49 in a sixth resonance mode;

FIG. 51 is a 3D pattern of the antenna structure in FIG. 49 in a sixth resonance mode;

FIG. 52 is a diagram of S11 of the antenna structure in FIG. 49;

FIG. 53 is a diagram of efficiency of the antenna structure in FIG. 49;

FIG. 54 is an E-plane pattern of the antenna structure in FIG. 49; and

FIG. 55 is an H-plane pattern of the antenna structure in FIG. 49.

### REFERENCE NUMERALS

10: electronic device; 11: metal ring housing; 12: antenna structure;
13: circuit board; 14: first radiation structure; 15: second radiation structure;
16: metal member; 17: first cover plate; 141: first radiation ring;
142: stub; 151: second radiation ring; 152: second grounding stub;
121: first radiator; 122: second radiator; 171: conductive area;
1412: slit; 1421: feed stub; 1422: first grounding stub.

### DETAILED DESCRIPTION

To make objectives, technical solutions, and advantages of this application clearer, the following further describes this application in detail with reference to the accompanying drawings.

To facilitate understanding of an electronic device provided in embodiments of this application, the following first describes an application scenario of the electronic device. The electronic device provided in embodiments of this application is applicable to use of one or more of the following communication technologies: a Bluetooth (BT) communication technology, a global positioning system (GPS) communication technology, a wireless fidelity (Wi-Fi) communication technology, a global system for mobile communications (GSM) communication technology, a wideband code division multiple access (WCDMA) communication technology, a long term evolution (LTE) communication technology, a 5G communication technology, another future communication technology, and the like. The electronic device in embodiments of this application may be a smart home product, a mobile phone, a tablet computer, a notebook computer, a smart band, a smartwatch, a smart sensing apparatus (for example, a smart sensing camera), a robot, or the like. Alternatively, the electronic device may be a handheld device with a wireless communication function, a compute device or another processing device connected to a wireless modem, a vehicle-mounted device, an electronic device in a 5G network, an electronic device in a future evolved public land mobile network (PLMN), or the like. This is not limited in embodiments of this application.

Any one of the foregoing electronic devices may include the electronic device in embodiments of this application, to implement a communication or detection function of the electronic device. In a specific embodiment, an antenna structure in the electronic device may be directly mounted in the electronic device, and is electrically connected to a processor in the electronic device, to implement a communication function and/or a detection function of the electronic device. Alternatively, an antenna structure may be integrated into a sensor or a sensing module, then the sensor or the sensing module is mounted in the electronic device, and a processor of the electronic device is electrically connected to the sensor or the sensing module, to implement a communication function and/or a detection function of the electronic device. The processor may be a chip provided that the processor can process data and implement at least some functions of the electronic device. This is not limited in this application.

For ease of understanding embodiments of this application, the following briefly describes terms in embodiments of this application.
Connection: The connection may indicate a mechanical connection relationship or a physical connection relationship. To be specific, that A and B are connected may indicate that there is a fastening component (for example, a screw, a bolt, or a rivet) between A and B, or A and B are in contact with each other and A and B are difficult to be separated.
Circuit board: The circuit board may be a printed circuit board (PCB), for example, an 8-layer, 10-layer, or 12-layer to 14-layer board with 8, 10, 12, 13, or 14 layers of conductive materials, or an element that is separated and electrically insulated by a dielectric layer or an insulation layer, for example, a glass fiber or a polymer. In this application, the circuit board may include a signal layer and a grounding plane. The signal layer is electrically coupled to a feed power supply, and is configured to perform signal transmission with another component of the electronic device. The grounding plane is a metal layer in the circuit board and is isolated from the signal layer. The grounding plane is configured to connect to another component of the electronic device in a grounding manner.

Any of the foregoing grounding plane, grounding plate, or grounding metal layer is made of a conductive material. In an embodiment, the conductive material may be any one of the following materials: copper, aluminum, stainless steel, brass and an alloy thereof, copper foil on an insulation substrate, aluminum foil on an insulation substrate, gold foil on an insulation substrate, silver-plated copper, silver-plated copper foil on an insulation substrate, silver foil on an insulation substrate, tin-plated copper, cloth impregnated with graphite powder, a graphite-coated substrate, a copper-plated substrate, a brass-plated substrate, and an aluminum-plated substrate. A person skilled in the art may understand that the grounding plane/grounding plate/grounding metal layer may alternatively be made of another conductive material.
Signal connection: The signal connection means that a component is connected to a signal port of the circuit board, to transmit a signal between the component and the circuit board.
Grounding connection: The grounding connection means that a component is connected to the grounding plane, the grounding plate, or the grounding metal layer of the circuit board. In an embodiment, grounding may be grounding through an entity, for example, an electrical connection between a specific position on a housing and the grounding plane of the circuit board is performed through a part of mechanical parts of the housing (or referred to as entity grounding), that is, an electrical connection to the grounding plane of the circuit board is not performed through an inductive component or a winding inductor. In an embodiment, grounding may be grounding through a component, for example, an electrical connection to the grounding plane of the circuit board is performed through an inductive component or a winding inductor (or referred to as component grounding). Limitations such as symmetry (for example, axial symmetry or central symmetry), parallelism, perpendicularity, and sameness (for example, dimension sameness) mentioned in embodiments of this application are all for a conventional technology level, but are not absolutely strict definitions in a mathematical sense. For example, a stub perpendicular to the circuit board may have a deviation of a predetermined angle. In an embodiment, the predetermined angle may be an angle in a range of ±20°. For example, the deviation of the predetermined angle may be ±15°.
Radiation ring: The radiation ring is a radiation conductor for receiving/sending electromagnetic wave radiation in the antenna structure. In an embodiment, the radiation ring converts guided wave energy from a transmitter into a radio wave, or converts a radio wave into guided wave energy, to radiate and receive a radio wave. Modulated high-frequency current energy (or guided wave energy) generated by the transmitter is transmitted to a radiation conductor (corresponding to a radiation ring of a transmit antenna) for transmission, and the radiation ring converts the modulated high-frequency current energy into specific polarized electromagnetic wave energy and radiates the energy in a required direction. A radiation conductor (corresponding to a radiation ring of a receive antenna) for receiving converts specific polarized electromagnetic wave energy from a specific direction of space into modulated high-frequency current energy, and transmits the modulated high-frequency current energy to an input end of a receiver.

The radiation ring may also include a slot or a slit formed on a conductor, for example, a closed or semi-closed slot or slit formed on a conductor surface of the radiation ring.

The radiation ring may be a conductor with a specific shape and dimensions, for example, a circular ring or a polygon. A specific shape is not limited in this application. In an embodiment of this application, the radiation ring is a circular ring. In this application, the radiation ring may be manufactured by using different manufacturing processes. For example, the radiation ring includes a laser direct structuring (LDS) conduction pattern, or a metal sheet/metal body that is integrally formed/connectedly formed.

In this embodiment of this application, the radiation ring is connected to the circuit board through a stub. In an embodiment, the stub may include an LDS conductive pattern, a metal sheet/metal body that is integrally formed/connectedly formed, or a conductive through hole wrapped in an insulation material.
Feed stub: The feed stub is a connection component between the radiation ring of the antenna structure and the circuit board. The feed stub may directly transmit current waves or electromagnetic waves with different frequencies and forms.

Dimensions of the stub in this application include a length and a width. The length is a dimension of the stub in an extension direction, and the width is a dimension of the stub in a direction perpendicular to a length direction. In an embodiment, lengths of a plurality of stubs may be equal, and widths of the plurality of stubs may be equal. During actual application, dimensions of the plurality of stubs may not be completely equal, and a processing error is allowed. In an embodiment, that lengths are equal or widths are equal may be understood as that a difference between the lengths is within 5% or a difference between the widths is within 5%.
End/point: The “end/point” in a feed end/grounding end/feed point/grounding point/connection point of the radiation ring cannot be understood in a narrow sense as a point, and may also be considered as a section of radiation conductor that includes an endpoint and that is on the radiation ring; and cannot be understood in a narrow sense as an endpoint or an end portion that is disconnected from another radiation conductor, and may also be considered as a point or a section on a continuous radiation ring. In an embodiment, the “end/point” may include an endpoint of the radiation ring at a slit. For example, a first end of the radiation ring may be considered as a section of radiator on the radiation ring within 5 mm (for example, 2 mm) away from the slit. In an embodiment, the “end/point” may include a connection/coupling area that is on the radiation ring and that is connected to another conductive structure in a coupling manner. For example, the feed end/feed point may be a coupling area (for example, an area opposite to a part of the feed stub) that is on the radiation ring and that is connected to the feed stub in a coupling manner. For another example, the grounding end/grounding point may be a connection/coupling area that is on the radiation ring and that is connected to a grounding structure or a grounding circuit in a coupling manner.

Co-directional/Reverse current distribution mentioned in embodiments of this application should be understood as that directions of main currents on conductors on a same side are the same/reverse. In an embodiment, co-directional current distribution on a conductor may mean that currents on the conductor have no reverse point. In an embodiment, reverse current distribution on a conductor may mean that currents on the conductor have at least one reverse point. In an embodiment, co-directional current distribution on two conductors may mean that none of currents on the two conductors has a reverse point and the currents flow in a same direction. In an embodiment, reverse current distribution on two conductors may mean that none of currents on the two conductors has a reverse point and the currents flow in reverse directions. That currents on a plurality of conductors are co-directional/reverse may be correspondingly understood.
Antenna pattern: The antenna pattern is also referred to as a radiation pattern. The antenna pattern is a pattern in which relative field strength (a normalized modulus value) of an antenna radiation field changes with a direction at a specific distance from an antenna. The antenna pattern is usually indicated by two plane patterns that are perpendicular to each other in a maximum radiation direction of the antenna. The antenna pattern usually includes a plurality of radiation beams. A radiation beam with highest radiation strength is referred to as a main lobe, and the other radiation beams are referred to as minor lobes or side lobes. In the minor lobes, a minor lobe in an opposite direction of the main lobe is also referred to as a back lobe.
Antenna gain: The antenna gain indicates a degree to which an antenna intensively radiates input power. Usually, a narrower main lobe of the antenna pattern indicates a smaller minor lobe, and a higher antenna gain.
Resonance frequency: The resonance frequency is also referred to as a resonant frequency. The resonance frequency may have a frequency range, namely, a frequency range in which resonance occurs. The resonance frequency may be a frequency range in which a return loss characteristic is less than −6 dB. A frequency corresponding to a strongest resonance point is a center frequency or a point frequency. A return loss characteristic of the center frequency may be less than −20 dB.
Resonance frequency band: A range of a resonance frequency is the resonance frequency band, and a return loss characteristic of any frequency on the resonance frequency band may be less than −6 dB or −5 dB.
Operating frequency band: Regardless of a type of antenna, the antenna always operates in a specific frequency range (a frequency band width). For example, an operating frequency band of an antenna supporting a B40 frequency band includes a frequency in a range of 2300 MHz to 2400 MHz. In other words, the operating frequency band of the antenna includes the B40 frequency band. A frequency range that meets a requirement of an indicator may be considered as an operating frequency band of an antenna. A width of the operating frequency band is referred to as an operating bandwidth. An operating bandwidth of an omnidirectional antenna may reach 3% to 5% of a center frequency. An operating bandwidth of a directional antenna may reach 5% to 10% of a center frequency. The bandwidth may be considered as a range of frequencies on both sides of the center frequency (for example, a resonance frequency of a dipole), where an antenna characteristic is in an acceptable range of values for the center frequency.

A resonance frequency band and an operating frequency band may be the same or different, or frequency ranges thereof may partially overlap. In an embodiment, the resonance frequency band of the antenna may cover a plurality of operating frequency bands of the antenna.
Wavelength λ: The wavelength λ is also referred to as an operating wavelength, and may be a free space wavelength corresponding to a resonance point frequency or a free space wavelength corresponding to a center frequency of an operating frequency band supported by an antenna. For example, it is assumed that a center frequency of an uplink frequency band of the antenna (with a resonance frequency ranging from 1920 MHz to 1980 MHz) is 1955 MHz. In this case, an operating wavelength may be a wavelength calculated by using the frequency of 1955 MHz. The “operating wavelength” is not limited to the center frequency, and may alternatively be a free space wavelength corresponding to a non-center frequency of the resonance frequency or the operating frequency band.
Return loss: The return loss may be understood as a ratio of power of a signal reflected back to an antenna port through an antenna circuit to transmit power of the antenna port. A smaller reflected signal indicates a larger signal radiated by an antenna to the space and higher radiation efficiency of the antenna. A larger reflected signal indicates a smaller signal radiated by the antenna to the space and lower radiation efficiency of the antenna.
Radiation efficiency: The radiation efficiency is a ratio of power radiated by an antenna to the space (namely, power that is effectively converted into an electromagnetic wave) to active power input to the antenna. Active power input to the antenna=Input power of the antenna-Loss power. The loss power mainly includes return loss power and metal ohmic loss power and/or dielectric loss power. Both a metal loss and a dielectric loss are factors that affect the radiation efficiency.

A person skilled in the art may understand that efficiency is usually indicated by a percentage, and there is a corresponding conversion relationship between the efficiency and dB. Efficiency closer to 0 dB indicates better efficiency of the antenna.
dB: The dB is a decibel, and is a logarithmic concept with ten as a base. The decibel is only used to evaluate a proportional relationship between a physical quantity and another physical quantity, and has no physical dimension. Each time a ratio between the two quantities increases by 10 times, a difference between the two quantities may be indicated as 10 decibels. For example, if A=“100”, B=“10”, C=“5”, and D=“1”, A/D=20 dB, B/D=10 dB, C/D=7 dB, and B/C=3 dB. In other words, a difference of 10 decibels between the two quantities indicates that the difference is 10 times, a difference of 20 decibels between the two quantities indicates that the difference is 100 times, and the rest may be deduced by analogy. A difference of 3 dB indicates that the difference between the two quantities is twice.
dBi: The dBi is usually mentioned together with dBd. dBi and dBd are units of a power gain, and are relative values with different references. The reference for dBi is an omnidirectional antenna, and the reference for dBd is a dipole antenna. Usually, dBi and dBd indicate a same gain. A value indicated by dBi is greater than that indicated by dBd by 2.15 dBi. For example, for an antenna with a gain of 16 dBd, the gain is 18.15 dBi when measured in dBi, and is usually 18 dBi when decimal places are ignored.
Antenna return loss: The antenna return loss may be understood as a ratio of power of a signal reflected back to an antenna port through an antenna circuit to transmit power of the antenna port. A smaller reflected signal indicates a larger signal radiated by an antenna to the space and higher radiation efficiency of the antenna. A larger reflected signal indicates a smaller signal radiated by the antenna to the space and lower radiation efficiency of the antenna.

The antenna return loss may be indicated by an S11 parameter, and S11 is one of S parameters. S11 indicates a reflection coefficient, and the parameter can indicate transmit efficiency of the antenna. In an embodiment, an S11 diagram may be understood as a diagram of resonance generated by the antenna. In an embodiment, a part that is of the resonance shown in the S11 diagram and that is less than −6 dB may be understood as a resonance frequency/a frequency range/an operating frequency band generated by the antenna. The S11 parameter is usually a negative number. A smaller S11 parameter indicates a smaller antenna return loss, less energy reflected back by the antenna, namely, more energy that actually enters the antenna, and higher total efficiency of the antenna. A larger S11 parameter indicates a larger antenna return loss and lower total efficiency of the antenna.

It should be noted that, an S11 value of −6 dB is usually used as a standard in engineering. When an S11 value of the antenna is less than −6 dB, it may be considered that the antenna can operate normally, or it may be considered that transmit efficiency of the antenna is high.

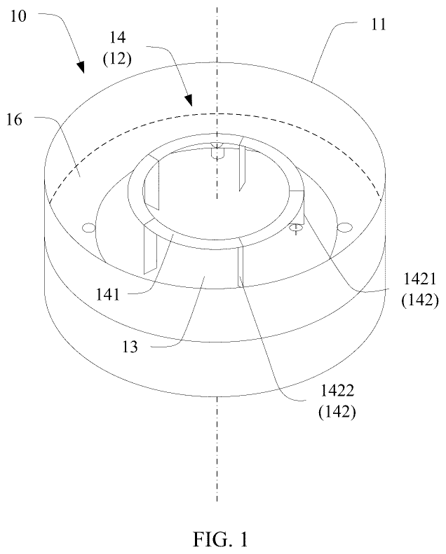

The following uses a smart button switch as an example to describe an electronic device in which an antenna structure is disposed in embodiments of this application. FIG. 1 is a diagram of a structure of an electronic device according to an embodiment of this application. As shown in FIG. 1, the electronic device 10 in this embodiment of this application includes an outer casing and an antenna structure 12. In an embodiment, the antenna structure 12 is disposed inside the outer casing, and the antenna structure 12 includes a circuit board 13. In this application, the outer casing may include a metal ring housing 11. The circuit board 13 includes a ground plane or a grounding plane. The metal ring housing 11 extends in an axial direction (a direction shown by a dot-dashed line in FIG. 1), and the axial direction of the metal ring housing 11 is disposed at an included angle with the circuit board 13. For example, in a specific embodiment, as shown in FIG. 1, the axial direction of the metal ring housing 11 is disposed at an included angle of 90 degrees with the circuit board 13, in other words, the axial direction of the metal ring housing 11 is perpendicular to the circuit board 13. In FIG. 1, only an example in which the electronic device 10 is a smart button switch is used. During actual application, the electronic device 10 in this embodiment of this application may alternatively be a terminal device, for example, a smart button, a smart band, or a tablet computer. This is not limited in this application.

With popularization of personalized customization, there are increasing requirements for overall aesthetics of the electronic device. To reflect different appearance textures, outer casings of electronic devices may be made of different materials such as plastic, metal, and wood. An outer casing made of a metal material is used as an example. It should be understood that the metal outer casing wraps the antenna structure, which affects performance of the antenna structure. Therefore, how to improve radiation performance of an antenna while meeting personalized customization of a user is particularly important.

Therefore, this application provides an antenna structure and an electronic device, to implement a high-efficiency omnidirectional radiation mode of an antenna structure, thereby improving radiation efficiency and directivity of the antenna structure in a metal ring housing.

It should be noted that terms used in the following embodiments are merely intended to describe specific embodiments, but are not intended to limit this application. The terms “one”, “a”, “the”, “the foregoing”, “this”, and “the one” of singular forms used in this specification and the appended claims of this application are also intended to include forms such as “one or more”, unless otherwise specified in the context clearly.

Reference to “an embodiment”, “some embodiments”, or the like described in this specification indicates that one or more embodiments of this application include a specific feature, structure, or characteristic described with reference to embodiments. Therefore, statements such as “in an embodiment”, “in some embodiments”, “in some other embodiments”, and “in other embodiments” that appear at different places in this specification do not necessarily mean reference to a same embodiment. Instead, the statements mean “one or more but not all of embodiments”, unless otherwise emphasized in another manner. The terms “include”, “comprise”, “have”, and their variants all mean “include but are not limited to”, unless otherwise emphasized in another manner.

Still refer to FIG. 1. In this embodiment of this application, an outer surface of the metal ring housing 11 may be used as a part of an appearance surface of the electronic device 10. During actual application, the metal ring housing 11 may be an annular housing enclosed by a metal plate material. That the metal ring housing 11 extends in the axial direction may be understood as that a thickness of the metal ring housing 11 (namely, a thickness of the metal plate material) is less than a length of the metal ring housing 11 in the axial direction.

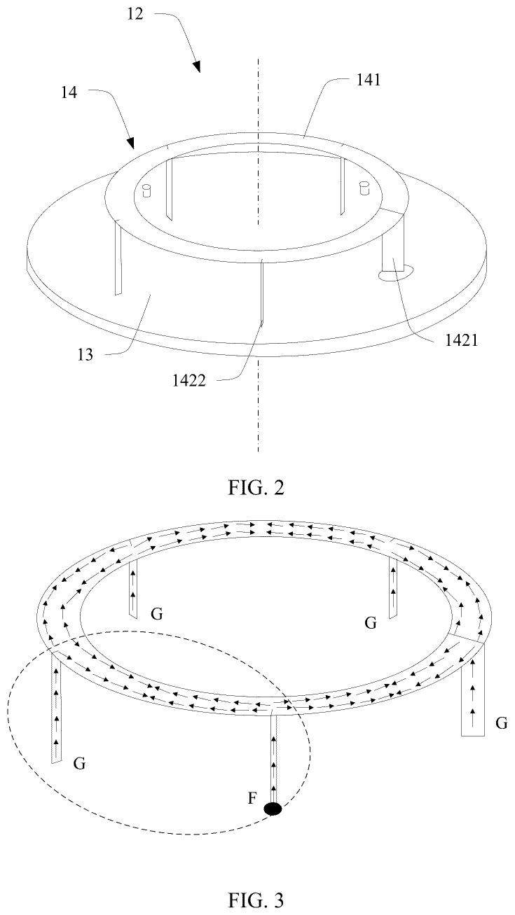

FIG. 2 is a diagram of a structure of the antenna structure according to an embodiment of this application. As shown in FIG. 1 and FIG. 2, the antenna structure 12 further includes a first radiation structure 14. In an embodiment, the first radiation structure 14 includes a first radiation ring 141 and a plurality of stubs 142. An axial direction of the first radiation ring 141 is parallel to the axial direction of the metal ring housing 11, in other words, the axial direction of the first radiation ring 141 is disposed at an included angle with the circuit board 13. It should be noted that, in this embodiment of this application, that axial directions are parallel may mean that two axial directions are in a same direction, but two axes do not overlap; or may mean that two axial directions are in a same direction, and two axes overlap. The plurality of stubs 142 are located between the first radiation ring 141 and the circuit board 13, and are electrically connected to the first radiation ring 141 and the circuit board 13. These stubs 142 are distributed in a circumferential direction of the first radiation ring 141. In an embodiment, the plurality of stubs 142 include one feed stub 1421 and at least one first grounding stub 1422. The feed stub 1421 is signal-connected to the circuit board 13, in other words, the feed stub 1421 is electrically connected to a signal layer of the circuit board 13. The at least one first grounding stub 1422 is connected to the circuit board 13 in a grounding manner, in other words, the first grounding stub 1422 is electrically connected to a grounding plane of the circuit board 13. In an embodiment, at least two first grounding stubs 1422 may be electrically connected to the grounding plane of the circuit board 13 without through an inductive component or a winding inductor, in other words, the first grounding stub 1422 is directly electrically connected to the grounding plane of the circuit board 13. In this application, a specific quantity of first grounding stubs 1422 is not limited. For example, the at least one first grounding stub 1422 may include one first grounding stub, two first grounding stubs, three first grounding stubs, four first grounding stubs, six first grounding stubs, eight first grounding stubs, or the like. The specific quantity of first grounding stubs 1422 may be determined based on a circumference of the first radiation ring 141, a length of the first grounding stub 1422, and a target operating frequency band of the antenna structure 12. In embodiments shown in FIG. 1 and FIG. 2, an example in which the quantity of first grounding stubs 1422 is 4 is used for illustration.

FIG. 3 is a diagram of current distribution of the first radiation structure in FIG. 2 in a first resonance mode. As shown in FIG. 3, the first radiation structure 14 is configured to generate first resonance. In an embodiment, any two adjacent stubs 142 may divide the first radiation ring 141 into a first section and a second section. A length of the second section in the circumferential direction of the first radiation ring 141 is greater than a length of the first section in the circumferential direction of the first radiation ring 141. The first radiation structure 14 includes a plurality of first antenna substructures (as shown by dashed lines in FIG. 3), and each first antenna substructure includes two adjacent stubs 142 and a first section that is of the first radiation ring 141 and that is located between the two adjacent stubs 142. In the first resonance mode, the first radiation structure 14 may be equivalently formed by connecting the plurality of first antenna substructures, to implement a high-efficiency omnidirectional radiation mode of the antenna structure 12, thereby improving radiation efficiency and directivity of the antenna structure 12 in the metal ring housing 11.

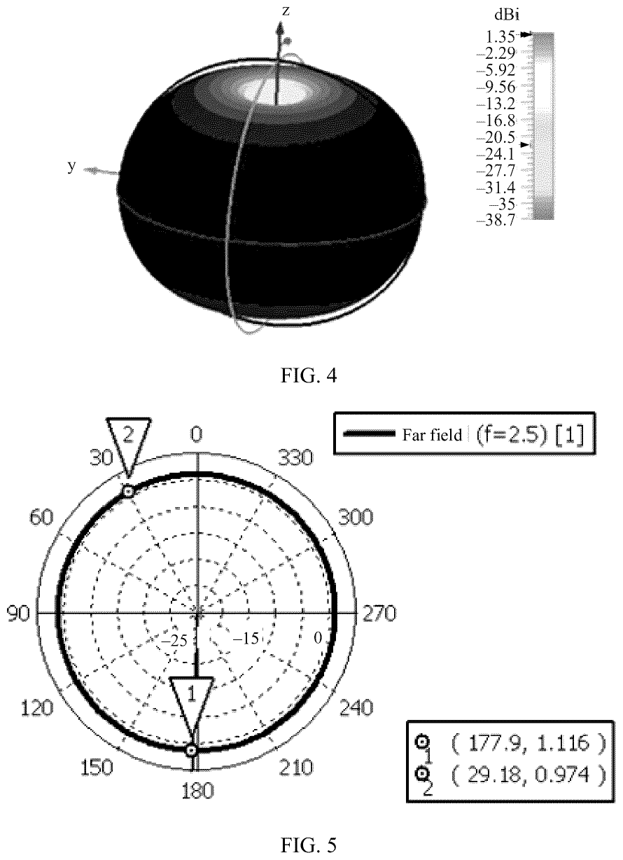

Still refer to FIG. 3. In a specific embodiment, the plurality of stubs 142 are evenly distributed in the circumferential direction of the first radiation ring 141, and may include one feed stub 1421 and four first grounding stubs 1422. In this embodiment, the first radiation structure 14 includes five first antenna substructures. When the feed stub 1421 feeds the first radiation ring 141, each first antenna substructure generates a loop antenna mode of 0.5λ, and current distribution on each first antenna substructure is similar. In an embodiment, current distribution of a single first antenna substructure includes first co-directional current distribution on two adjacent stubs 142 and first reverse current distribution on a section that is of the first radiation ring 141 and that is located between the two stubs 142, and the first reverse current distribution has one current reverse point (which may also be referred to as a current weak point). In this case, the first radiation structure 14 generates a fundamental mode f1, namely, the first resonance mode. FIG. 4 is a 3D pattern of the fundamental mode f1 of the antenna structure in FIG. 3, and FIG. 5 is a horizontal-plane pattern of the fundamental mode f1 of the antenna structure in FIG. 3. As shown in FIG. 4 and FIG. 5, when the plurality of stubs 142 are evenly distributed in the circumferential direction of the first radiation ring 141 and dimensions of the plurality of stubs 142 are the same, the plurality of stubs 142 and the plurality of first antenna substructures formed by the first radiation ring 141 are the same, each first antenna substructure has same current distribution, each stub 142 (including a feed stub 1421 and a first grounding stub 1422) has co-directional current distribution, and currents of the first radiation ring 141 between two adjacent stubs 142 are reverse. As shown in FIG. 4 and FIG. 5, the antenna structure 12 in this embodiment has good horizontal-plane coverage in the first resonance mode, and horizontal-plane out-of-roundness is within 2 dB. A length of a section that is of the first radiation ring 141 and that is located between two adjacent stubs 142 is d1, lengths of the two stubs 142 adjacent to the section are respectively d2 and d3, and a sum of d1, d2, and d3 is equal to (0.5±0.125)λ. For example, the sum of d1, d2, and d3 may be equal to 0.375λ, 0.46λ, 0.489λ, 0.5λ, 0.56λ, 0.6λ, 0.613λ, 0.625λ, or the like. This is not limited herein. λ is a free space wavelength corresponding to a resonance point frequency of the first resonance.

It should be noted that, that the plurality of stubs 142 are evenly distributed in the circumferential direction of the first radiation ring 141 means that a first section located between any two adjacent stubs 142 has an equal length. That the dimensions of the plurality of stubs 142 are the same means that lengths of the plurality of stubs 142 in extension directions (for example, vertical directions in FIG. 3) are equal, widths perpendicular to the length directions are equal, and included angles between the extension directions of the plurality of stubs 142 and the circuit board 13 are equal.

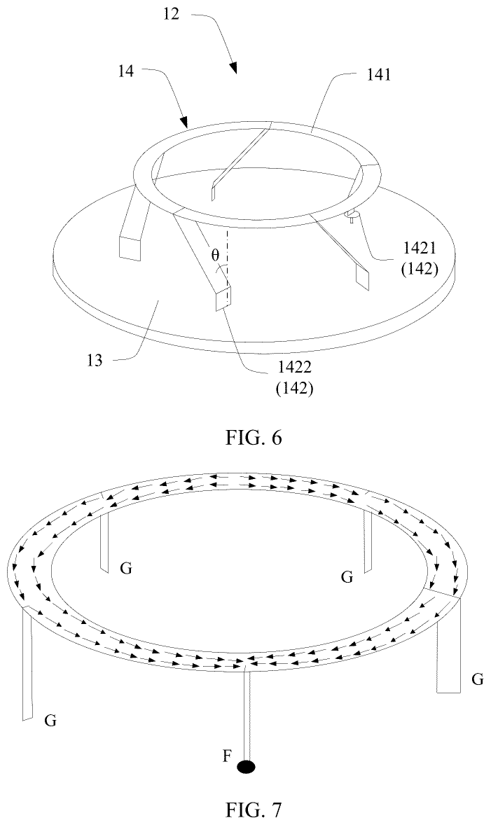

FIG. 6 is a diagram of another structure of an electronic device according to an embodiment of this application. As shown in FIG. 6, during actual application, due to different manufacturing processes of stubs 142, included angles θ between extension directions of the stubs 142 and a perpendicular direction of a circuit board 13 may be unequal. For example, the included angle θ may be less than or equal to 45 degrees. In an embodiment, the plurality of stubs 142 may be LDS conductive patterns and have equal dimensions. In an embodiment, the plurality of stubs 142 may be sequentially inclined in a counterclockwise direction, so that the stubs 142 are evenly arranged, and a manufacturing process of an antenna structure 12 is simplified. In this application, stubs 142 with different inclination angles have small impact on a resonance frequency and a pattern of a first resonance mode, a radiation efficiency difference is within 0.2 dB, and efficiency of the electronic device 10 at 2.4 GHz is approximately −3 dB.

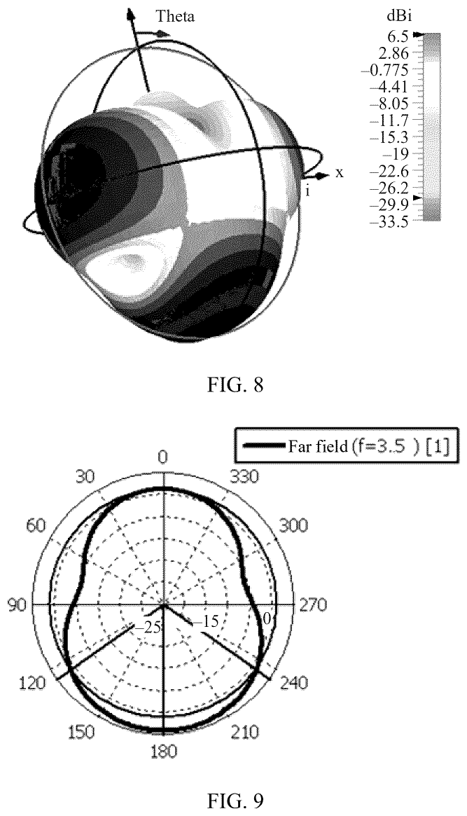

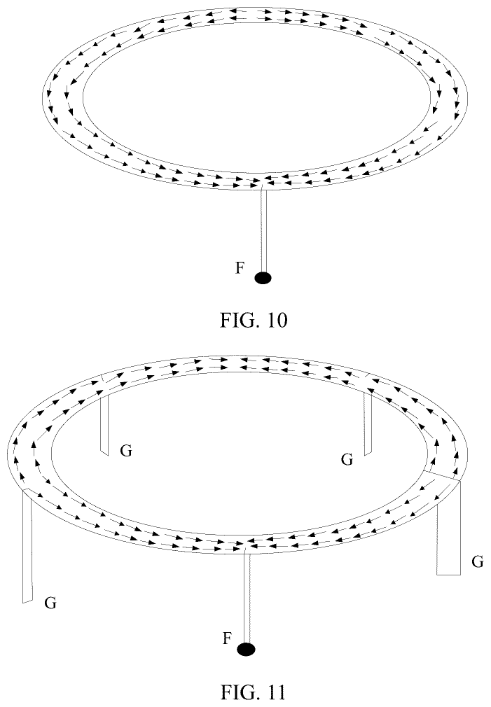

During actual application, the electronic device 10 may be configured to generate a plurality of operating modes. According to a specific application requirement, the electronic device 10 may meet a requirement of a dual-frequency or multi-frequency scenario. FIG. 7 is a diagram of current distribution of the first radiation structure in FIG. 1 in a second resonance mode. As shown in FIG. 7, when the feed stub 1421 feeds the first radiation ring 141, the first radiation ring 141 may be further configured to generate second resonance, and a resonance point frequency of the second resonance is higher than the resonance point frequency of the first resonance. The second resonance mode corresponds to a 1λ mode of the first radiation ring 141, namely, a mode f2 of the antenna structure 12. The mode f2 is a 1λ convection mode, and current distribution of the mode f2 includes second reverse current distribution on the first radiation ring 141 and has two current reverse points. A 3D pattern and a horizontal-plane pattern of the mode f2 are shown in FIG. 8 and FIG. 9. FIG. 8 is the 3D pattern of the mode f2 of the antenna structure in FIG. 7, and FIG. 9 is the horizontal-plane pattern of the mode f2 of the antenna structure in FIG. 7. In the second resonance mode, existence of the at least one first grounding stub 1422 does not affect existence of the second resonance mode. FIG. 10 is a diagram of current distribution obtained after the first grounding stub is removed from the first radiation structure in FIG. 7. As shown in FIG. 10, the second resonance mode still exists after the first grounding stub 1422 is deleted. In an embodiment, the first grounding stub 1422 inductively loads the first radiation ring 141, so that the first radiation ring 141 has a frequency offset in the second resonance mode.

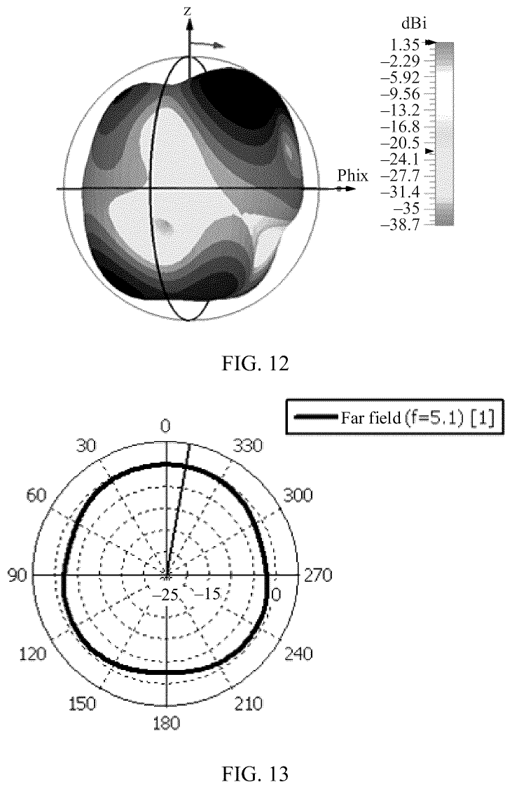

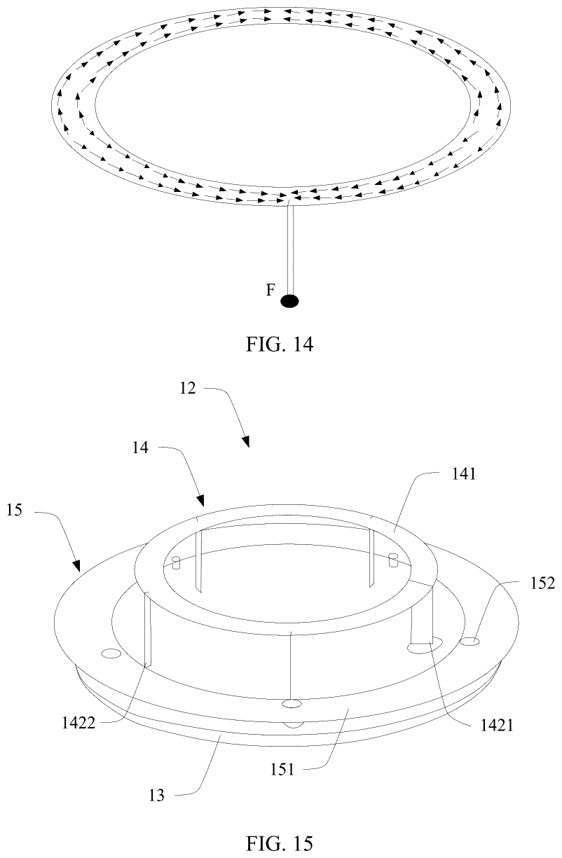

In another embodiment, when the feed stub 1421 feeds the first radiation ring 141, the first radiation ring 141 may be further configured to generate third resonance. FIG. 11 is a diagram of current distribution of the first radiation structure in FIG. 1 in a third resonance mode. As shown in FIG. 11, the first radiation ring 141 generates a 2λ mode of the first radiation ring 141, namely, the third resonance mode. The 2λ mode is a higher-order mode of the mode f2, namely, a mode f3. Current distribution of the mode f3 includes third reverse current distribution on the first radiation ring, and the third reverse current distribution has four current reverse points. A 3D pattern and a horizontal-plane pattern of the higher-order mode f3 are shown in FIG. 12 and FIG. 13. FIG. 12 is the 3D pattern of the mode f3 of the antenna structure in FIG. 11, and FIG. 13 is the horizontal-plane pattern of the mode f3 of the antenna structure in FIG. 11. In the third resonance mode, existence of the at least one first grounding stub 1422 does not affect existence of the third resonance mode. FIG. 14 is a diagram of current distribution obtained after the first grounding stub is removed from the first radiation structure in FIG. 11. As shown in FIG. 14, the third resonance mode still exists after the first grounding stub 1422 is deleted, and the first grounding stub 1422 inductively loads the first radiation ring 141, so that the first radiation ring 141 has a frequency offset in the third resonance mode.

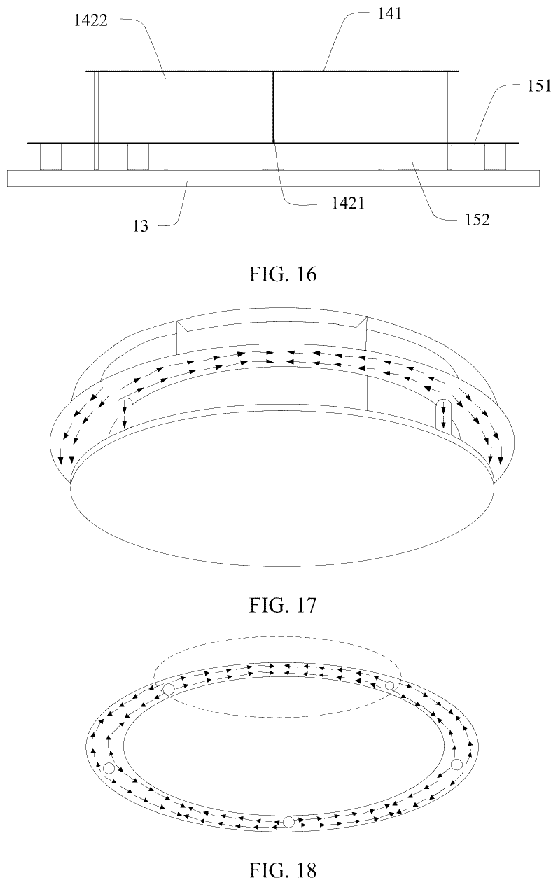

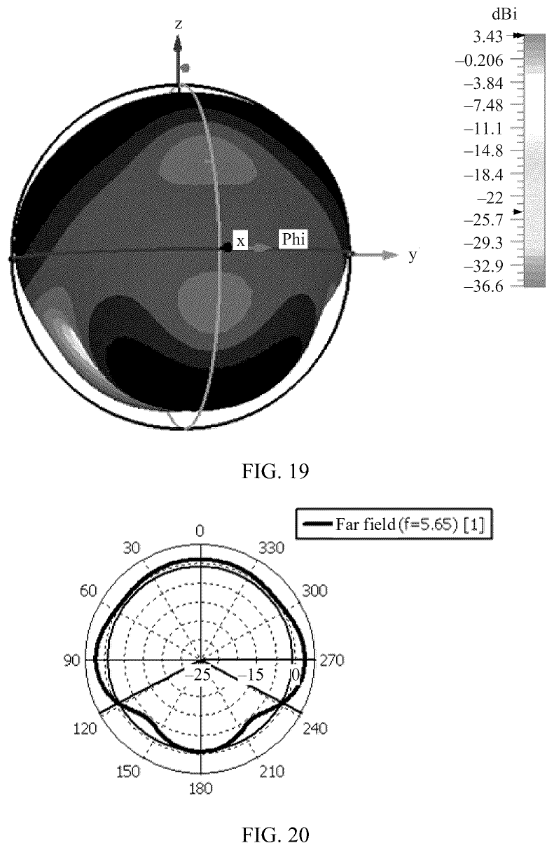

FIG. 15 is a diagram of another structure of the antenna structure according to an embodiment of this application. FIG. 16 is a side view of the antenna structure in FIG. 15. As shown in FIG. 15 and FIG. 16, in addition to resonance generated by the first radiation ring 141, the antenna structure 12 may further include a second radiation structure 15. The second radiation structure 15 includes a second radiation ring 151 and at least two second grounding stubs 152, to generate other resonance. In an embodiment, an axial direction of the second radiation ring 151 is parallel to an axial direction of the first radiation ring 141, second radiation rings 151 are spaced apart on an outer periphery of the first radiation ring 141, and a minimum inner diameter of the second radiation ring 151 is greater than a maximum outer diameter of the first radiation ring 141 and is less than a minimum inner diameter of the metal ring housing 11. The at least two second grounding stubs 152 are connected between the second radiation ring 151 and the circuit board 13, and the at least two second grounding stubs 152 are disposed in the axial direction of the second radiation ring 151. FIG. 17 is a diagram of current distribution of the second radiation structure in the antenna structure in FIG. 15 in the fourth resonance mode. FIG. 18 is another diagram of current distribution of the second radiation structure in FIG. 15 in a fourth resonance mode. FIG. 17 is a bottom view of the antenna structure in FIG. 15, and FIG. 18 is a bottom view of the second radiation structure in FIG. 15. As shown in FIG. 17 and FIG. 18, in the electronic device 10, the second radiation ring 151 is configured to generate fourth resonance. In an embodiment, any two adjacent second grounding stubs 152 may divide the second radiation structure 15 into a third section and a fourth section. A length of the fourth end in a circumferential direction of the second radiation ring 151 is greater than a length of the third section in the circumferential direction of the second radiation ring 151. The second radiation structure 15 includes a plurality of second antenna substructures (as shown by dashed lines in FIG. 18), and current distribution on each second antenna substructure is similar. Each second antenna substructure includes any two adjacent second grounding stubs 152, and a section that is of the second radiation ring 151 and that is between the two adjacent second grounding stubs 152 forms the second antenna substructure (as shown by dashed lines in FIG. 18). Each second antenna substructure includes two adjacent second grounding stubs 152 and a third section that is of the second radiation ring 151 and that is located between the two adjacent second grounding stubs 152. Therefore, in the fourth resonance mode, the second radiation structure 15 may be equivalently formed by connecting the plurality of second antenna substructures, to further improve radiation efficiency and directivity of the antenna structure 12 in the metal ring housing 11. Current distribution of a single second antenna substructure includes second co-directional current distribution on two adjacent second grounding stubs 152 and fourth reverse current distribution on a section that is of the second radiation ring 151 and that is located between the two second grounding stubs 152, and the fourth reverse current distribution has one current reverse point. In this case, the second radiation structure 15 generates a mode f4, namely, the fourth resonance mode. FIG. 19 is a 3D pattern of the mode f4 of the antenna structure in FIG. 18, and FIG. 20 is a horizontal-plane pattern of the mode f4 of the antenna structure in FIG. 18. Therefore, the antenna structure 12 has better omnidirectional radiation in the fourth resonance mode.

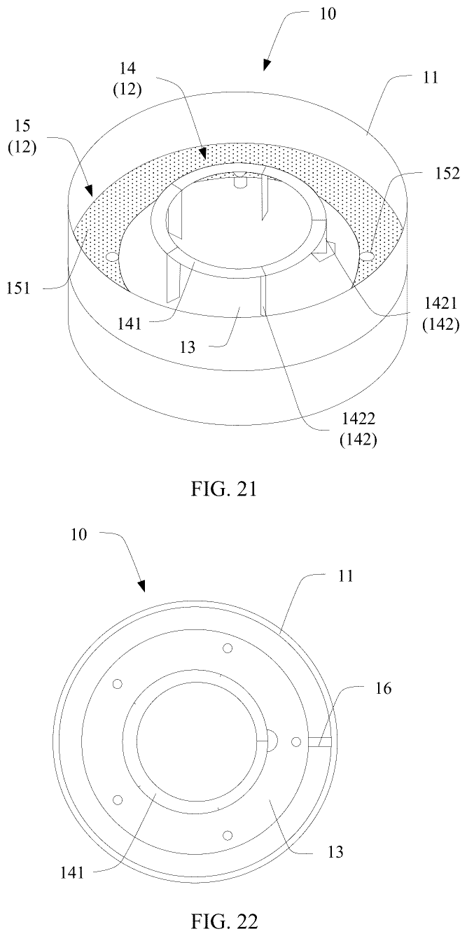

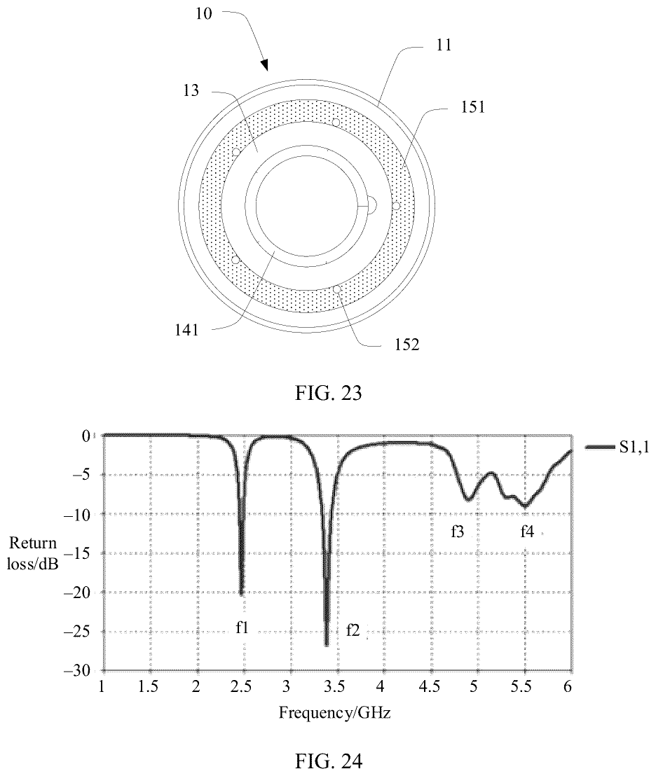

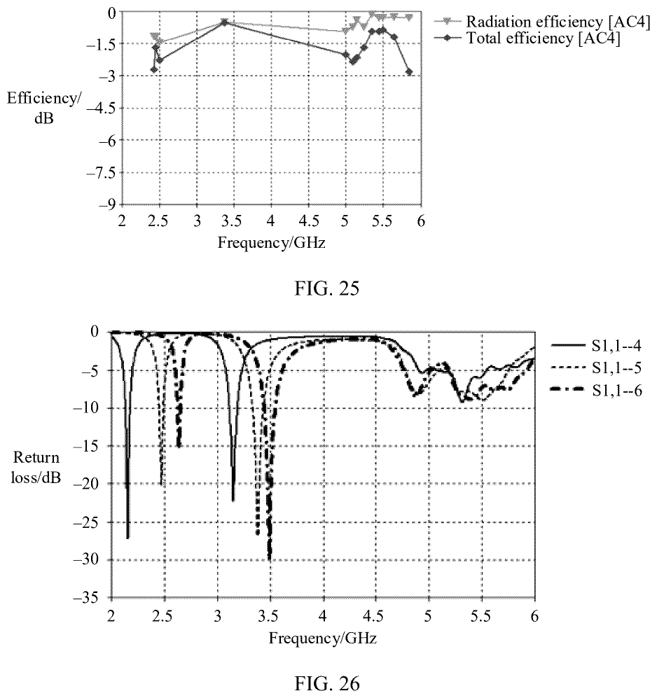

FIG. 21 is a diagram of another structure of an electronic device according to an embodiment of this application. As shown in FIG. 21, in an embodiment, a height of a metal ring housing 11 in an axial direction may be 0.22λ. A height of the metal ring housing 11 on a side that is of a circuit board 13 and that faces a first radiation structure 14 may be 0.11λ in the axial direction. That is, the circuit board 13 is located in the metal ring housing 11 and is centered in a height direction of the metal ring housing 11. FIG. 22 is a diagram of another structure of an electronic device according to an embodiment of this application. As shown in FIG. 1 and FIG. 22, in embodiments of this application, a metal ring housing 11 may be connected to a circuit board 13 through a metal member 16 in a grounding manner. In an embodiment, the metal member 16 may be an annular metal member. The annular metal member and the metal ring housing 11 may be of an integrated structure, or may be fastened in a manner of bonding, welding, or the like. In addition, the metal member 16 may be connected to the circuit board 13 through a plurality of grounding posts in a grounding manner, and the grounding post may be a bolt, a pin, or the like. Alternatively, as shown in FIG. 21, the metal ring housing 11 may be directly connected to the circuit board 13 through a plurality of grounding posts in a grounding manner. FIG. 23 is a diagram of another structure of an electronic device according to an embodiment of this application. As shown in FIG. 23, a metal ring housing 11 may alternatively not be connected to a circuit board 13 in a grounding manner. In the embodiment shown in FIG. 21, a plurality of stubs 142 of the first radiation structure 14 may include one feed stub 1421 and four first grounding stubs 1422, and each stub 142 is perpendicular to the circuit board 13. A length of each stub 142 is 0.09λ. A circumference of a first radiation ring 141 is 0.55λ, a circumference of a second radiation ring 151 is 1.15λ, and a distance between the second radiation ring 151 and the circuit board 13 is 0.044λ. It should be noted that dimensions of components in this embodiment are merely used for illustration, but do not limit the dimensions of the components. The electronic device 10 may be applied to a multi-frequency application scenario. An antenna structure 12 includes a first resonance mode (f1 includes 2.45 GHz), a second resonance mode (f2 includes 3.4 GHz), a third resonance mode (f3 includes 4.9 GHz), and a fourth resonance mode (f4 includes 5.5 GHz). The electronic device 10 in this embodiment may be applied to a dual-frequency application scenario of 2.4 GHz and 5 GHz. FIG. 24 is a diagram of S11 of the electronic device in FIG. 21, and FIG. 25 is a diagram of efficiency of the electronic device in FIG. 21. Efficiency of each operating frequency of the antenna structure 12 of the electronic device 10 is within −3 dB and has good out-of-roundness in the first resonance mode.

In the foregoing embodiment, a distance between the first radiation ring 141 and the metal ring housing 11 is greater than or equal to 0.024λ. In this way, the electronic device 10 can maintain better antenna efficiency. Further, on the side that is of the circuit board 13 and that faces the first radiation structure 14, a distance between the circuit board 13 and an end face that is of the metal ring housing 11 and that is away from the circuit board 13 is less than or equal to 0.22λ.

In an embodiment, the first radiation ring 141 is at a first distance from the circuit board 13, the second radiation ring 151 is at a second distance from the circuit board 13, and the first distance is greater than the second distance. In other words, by using the circuit board 13 as a reference, a height of the first radiation ring 141 is higher than a height of the second radiation ring 151, so that the first radiation ring 141 has high-efficiency radiation.

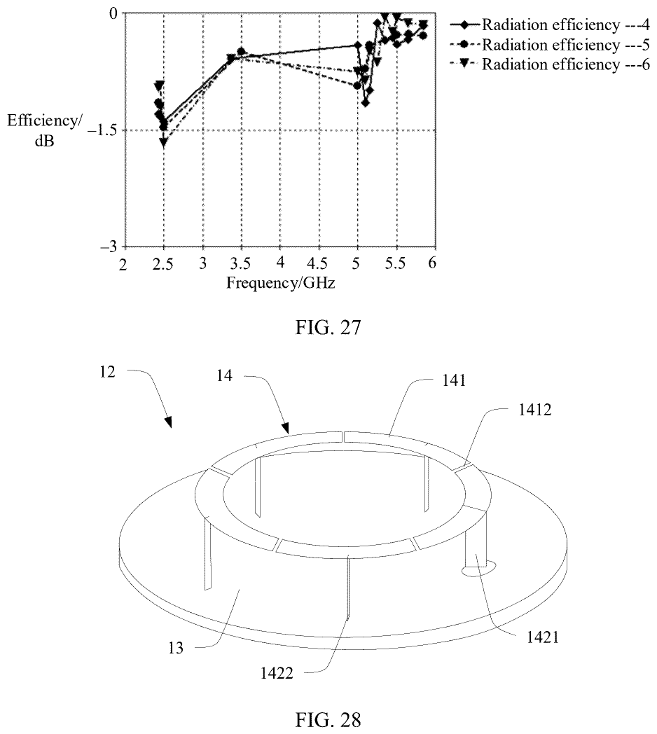

In this application, a width of the first grounding stub 1422 has small impact on a standing wave of the antenna structure 12. In an embodiment, first grounding stubs 1422 of different widths cause a frequency offset in the fundamental mode f1, and have small impact on the mode f2, the mode f3, and the mode f4. FIG. 26 is a diagram of comparison between resonance frequencies of antenna structures in FIG. 15 with different quantities of stubs, and FIG. 27 is a diagram of comparison between radiation efficiency of antenna structures with different quantities of stubs in FIG. 15. As shown in FIG. 26 and FIG. 27, when a plurality of stubs 142 are perpendicular to the circuit board 13 and the first radiation ring 141, in a first resonance mode, a decrease in a quantity of stubs 142 increases a resonance length of each first antenna substructure, and resonance shifts toward a low frequency; and an increase in the quantity of stubs 142 decreases the resonance length of each first antenna substructure, and the resonance shifts toward a high frequency. In a second resonance mode, when quantities of stubs 142 are different, a loading amount of the antenna structure 12 changes. In an embodiment, when the quantity of stubs 142 decreases, there is shifting toward a low frequency; and when the quantity of stubs 142 increases, there is shifting toward a high frequency. In addition, as shown in FIG. 26, the quantity of stubs 142 has relatively small impact on a third resonance mode and a fourth resonance mode. In addition, as shown in FIG. 27, a change in the quantity of the vertically disposed stubs 142 has small impact on radiation efficiency of the antenna structure 12, and a difference is within 0.5 dB.

In the foregoing embodiment, when resonance frequency of the fourth resonance mode needs to be adjusted, a quantity of second grounding stubs 152 may be adjusted. In addition, frequency ratios of a mode f2 and a mode f3 to a fundamental mode f1 may be adjusted through changes of a circumference of the first radiation ring 141 and a height of the stub 142.

FIG. 28 is a diagram of another structure of the antenna structure according to an embodiment of this application. As shown in FIG. 28, between two adjacent stubs 142, a first section of the first radiation ring 141 has a slit 1412 (or a slot), and the slit 1412 is located in a middle area of the first section. A length of the first section in a circumferential direction of the first radiation ring 141 is L, and the middle area is an area that is L/5 to L/3 from a length midpoint of the first section on two sides in the circumferential direction of the first radiation ring 141.

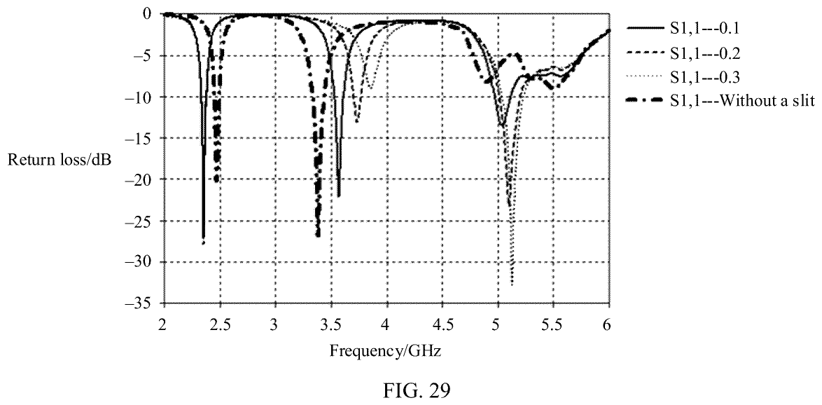

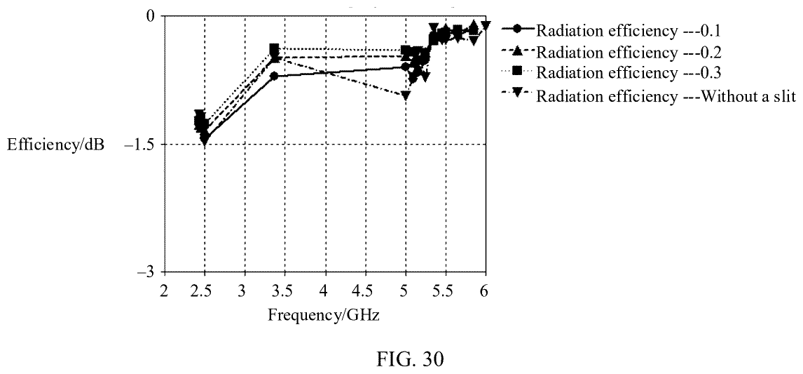

In an embodiment, a current node (namely, a current reverse point) of the fundamental mode f1 is located at the length midpoint of the first section, and the slit 1412 may be disposed at the current reverse point, to reduce impact of the slit 1412 on current distribution of a first antenna substructure. FIG. 29 is a diagram of comparison between S11 of antenna structures in FIG. 28 with slits of different widths, and FIG. 30 is a diagram of comparison between efficiency of antenna structures in FIG. 28 with slits of different widths. As shown in FIG. 29 and FIG. 30, slits 1412 of different widths do not affect existence of a resonance mode of the antenna structure 12, but generate a specific frequency offset. For the first resonance mode, a frequency in a case of having the slit 1412 is lower than that in a case of not having the slit 1412, and a width of the slit 1412 does not affect the frequency. For the second resonance mode, a frequency is relatively high after slitting, and a wider slit 1412 indicates a higher frequency. For the third resonance mode, a frequency is relatively high after slitting, and a wider slit 1412 indicates a higher frequency. For the fourth resonance mode, impact of slitting is relatively small. Therefore, an efficiency difference between an antenna structure 12 with a slit and an antenna structure 12 without a slit is within 0.5 dB, and impact of slitting is small.

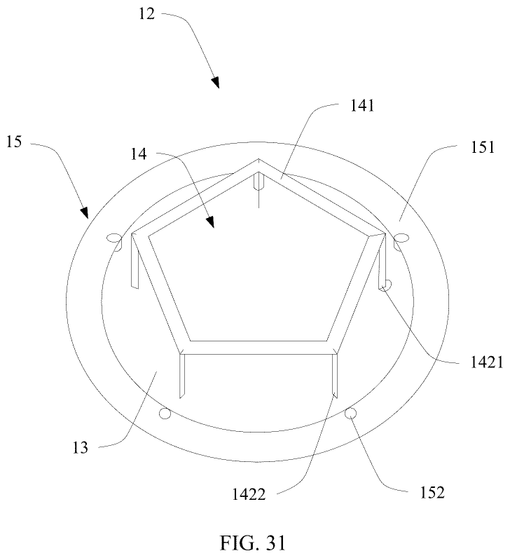

FIG. 31 is a diagram of the first radiation ring according to an embodiment of this application. As shown in FIG. 28 and FIG. 31, a shape of the first radiation ring 141 may include a circular ring or an ellipse ring; or a shape of the first radiation ring 141 may include a polygon, for example, a rectangle, a pentagon, a hexagon, or an octagon. Certainly, the shape of the first radiation ring 141 may alternatively include another irregular shape. This is not limited in this application.

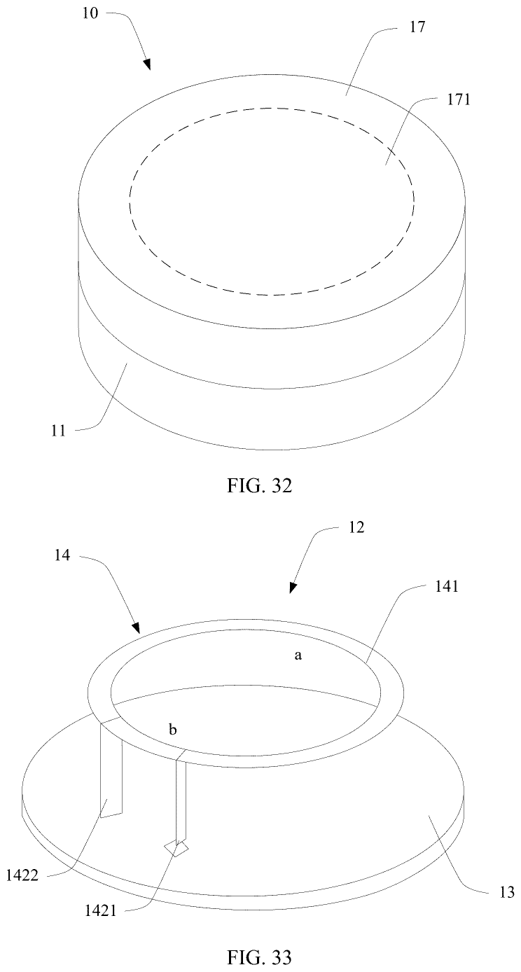

FIG. 32 is another diagram of an electronic device according to an embodiment of this application. As shown in FIG. 32, when the electronic device 10 is disposed, the electronic device 10 may further include a first cover plate 17 and a second cover plate (not shown in the figure). The first cover plate 17 and the second cover plate are respectively disposed at two ends of a metal ring housing 11, and enclose an accommodation cavity together with the metal ring housing 11. A circuit board 13 and an antenna structure 12 are disposed in the accommodation cavity. The first cover plate 17 may be further used as a display surface of the electronic device 10. In an embodiment, the first cover plate 17 is connected to the metal ring housing 11 in an insulated manner. The first cover plate 17 has a conductive area 171, and there is a gap between the conductive area 171 and the metal ring housing 11. To avoid impact of the metal ring housing 11 on a function of the conductive area 171, the gap may be set to be greater than or equal to 0.02λ.

During actual application, due to limitations such as layout space and a manufacturing process technology, a plurality of stubs 142 may be unevenly distributed in a circumferential direction of the first radiation ring. The following describes the antenna structure 12 in detail by using an example in which the plurality of stubs 142 are unevenly distributed.

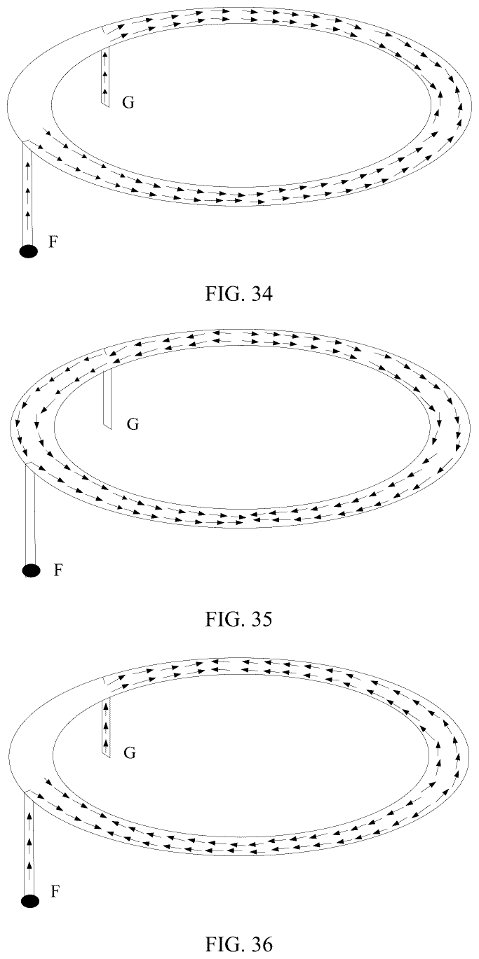

FIG. 33 is another diagram of the antenna structure according to an embodiment of this application. As shown in FIG. 33, the antenna structure 12 includes a first radiation structure 14. The first radiation structure 14 includes the first radiation ring 141 and the plurality of stubs 142. The plurality of stubs 142 include one feed stub 1421 and one first grounding stub 1422. The feed stub 1421 and the first grounding stub 1422 are asymmetrically disposed along the first radiation ring 141, and divide the first radiation ring 141 into a first radiation ring section a and a second radiation ring section b, and a length of the first radiation ring section a in the circumferential direction of the first radiation ring 141 is greater than a length of the second radiation ring section b in the circumferential direction of the first radiation ring 141. When the feed stub 1421 feeds the first radiation ring 141, the feed stub 1421, the first grounding stub 1422, and the first radiation ring section a form one third antenna substructure, the feed stub 1421, the first grounding stub 1422, and the second radiation ring section b form a fourth antenna substructure, and current distribution on the third antenna substructure is similar to that on the fourth antenna substructure. FIG. 34 is a diagram of current distribution of the first radiation structure in FIG. 33 in a first resonance mode. As shown in FIG. 34, in an embodiment, the current distribution of the third antenna substructure includes first co-directional current distribution on two adjacent stubs 142 and reverse current distribution on the first radiation ring section a and the second radiation ring section b, and the reverse current distribution on the first radiation ring section a and the reverse current distribution on the second radiation ring section b each have one current reverse point. In this case, the first radiation structure 14 generates a fundamental mode f1, namely, the first resonance mode. Because a circumference of the first radiation ring section a is greater than a circumference of the second radiation ring section b, the current distribution on the second radiation ring section b is weaker than the current distribution on the first radiation ring section a. When the circumference of the first radiation ring section a is far greater than the circumference of the second radiation ring section b, the current distribution on the second radiation ring section b may be ignored. In this case, the fundamental mode f1 is mainly generated by the third antenna substructure formed by the feed stub 1421, the first grounding stub 1422, and the first radiation ring section a.

Certainly, the electronic device 10 may also be configured to generate a plurality of operating modes. According to a specific application requirement, the electronic device 10 may meet a requirement of a dual-frequency or multi-frequency scenario. FIG. 35 is a diagram of current distribution of the first radiation structure in FIG. 33 in a second resonance mode. As shown in FIG. 35, in an embodiment, when the feed stub 1421 feeds the first radiation ring 141, the first radiation ring 141 may be further configured to generate second resonance, and a resonance point frequency of the second resonance is higher than a resonance point frequency of the first resonance. The second resonance mode corresponds to a 1λ mode of the first radiation ring 141, namely, a mode f2 of the antenna structure 12. The mode f2 is a 1λ convection mode, and current distribution of the mode f2 includes second reverse current distribution on the first radiation ring 141 and has two current reverse points.

In another embodiment, when the feed stub 1421 feeds the first radiation ring 141, the first radiation ring 141 may be further configured to generate third resonance. FIG. 36 is a diagram of current distribution of the first radiation structure in FIG. 33 in a third resonance mode. As shown in FIG. 36, in this embodiment, the third resonance corresponds to a 1.5λ mode of the antenna structure 12, and is indicated as a higher-order mode of the antenna structure 12, namely, a mode f3. The mode f3 is a higher-order mode of a fundamental mode f1, and a resonance point frequency of the third resonance is higher than a resonance point frequency of first resonance.

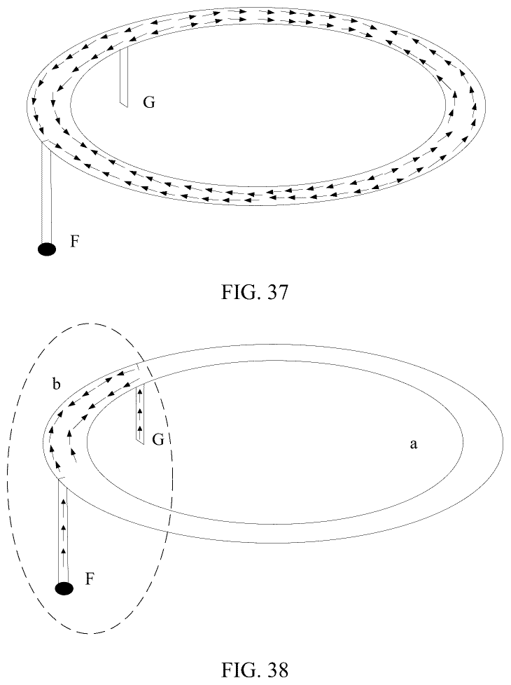

In another embodiment, when the feed stub 1421 feeds the first radiation ring 141, the first radiation ring 141 may be further configured to generate fourth resonance. FIG. 37 is a diagram of current distribution of the first radiation structure in FIG. 33 in a fourth resonance mode. As shown in FIG. 37, in this embodiment, the fourth resonance corresponds to a 2λ mode of the antenna structure, and is indicated as a higher-order mode of the antenna structure 12, namely, a mode f4. The mode f4 is a high-order mode of a mode f2, and a resonance point frequency of the fourth resonance is higher than a resonance point frequency of third resonance.

In another embodiment, when the feed stub 1421 feeds the first radiation ring 141, the first radiation ring 141 may be further configured to generate fifth resonance. FIG. 38 is a diagram of current distribution of the first radiation structure in FIG. 33 in a fifth resonance mode. As shown in FIG. 38, when the feed stub 1421 feeds the first radiation ring 141, the first radiation ring 141 may generate the fifth resonance, and the fifth resonance corresponds to a 0.5λ mode of the antenna structure 12, and is indicated as a mode f5 of the antenna structure 12. Current distribution of the mode 5 includes co-directional currents on the feed stub 1421 and the first grounding stub 1422 and a reverse current on the second radiation ring section b, and the reverse current has one current reverse point. Therefore, the mode f5 is mainly generated by the fourth antenna substructure formed by the feed stub 1421, the first grounding stub 1422, and the second radiation ring section b.

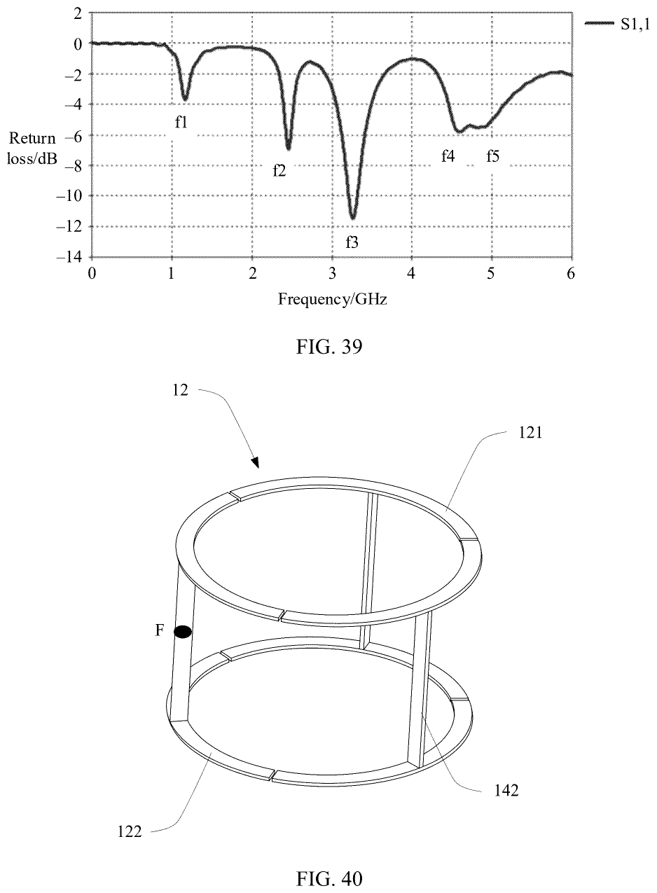

In an embodiment, when the feed stub 1421 feeds the first radiation ring 141, the first radiation ring 141 may be configured to generate first resonance, second resonance, third resonance, fourth resonance, and fifth resonance. FIG. 39 is a diagram of S11 of the antenna structure in FIG. 33 in a first resonance mode, a second resonance mode, a third resonance mode, a fourth resonance mode, and a fifth resonance mode. As shown in FIG. 39, the antenna structure 12 in this embodiment may generate a plurality of operating modes, and may be applied to a dual-band or multi-band application scenario.

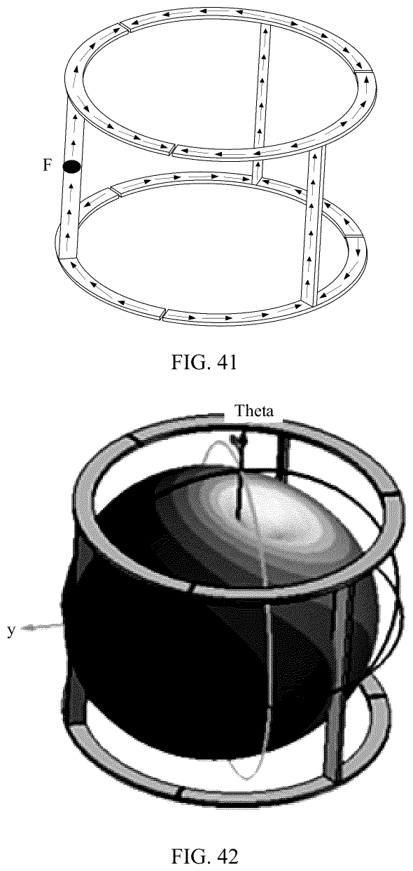

FIG. 40 is a diagram of another structure of the antenna structure according to an embodiment of this application. As shown in FIG. 40, in some other embodiments of this application, the electronic device 10 includes an outer casing (not shown in the figure) and the antenna structure 12, and the antenna structure 12 is disposed inside the outer casing. The antenna structure 12 includes a first radiator 121, a second radiator 122, and at least two stubs 142. The first radiator 121 and the second radiator 122 are the same and symmetrically disposed. In other words, a shape of the first radiator 121 is the same as a shape of the second radiator 122, and dimensions of the first radiator 121 is the same as dimensions of the second radiator 122. The at least two stubs 142 are connected between the first radiator 121 and the second radiator 122. That is, the first radiator 121 and the second radiator 122 are disposed opposite to each other, and the first radiator 121 and the second radiator 122 are symmetrically disposed relative to the stub 142.

In this application, a specific quantity of stubs 142 is not limited. For example, the at least two stubs 142 may include two stubs, three stubs, four stubs, six stubs, eight stubs, or the like. In the embodiment shown in FIG. 40, an example in which the quantity of stubs 142 is 3 is used for illustration.

Still refer to FIG. 40. The antenna structure 12 further includes a feed point F. The feed point F may be located on one of the at least two stubs 142. Alternatively, the feed point F may be located on the first radiator 121, and disposed close to one of the at least two stubs 142.

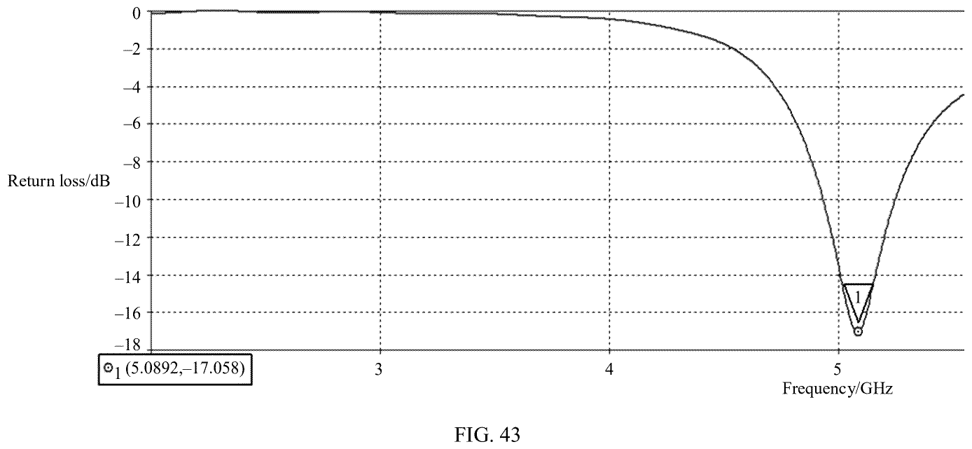

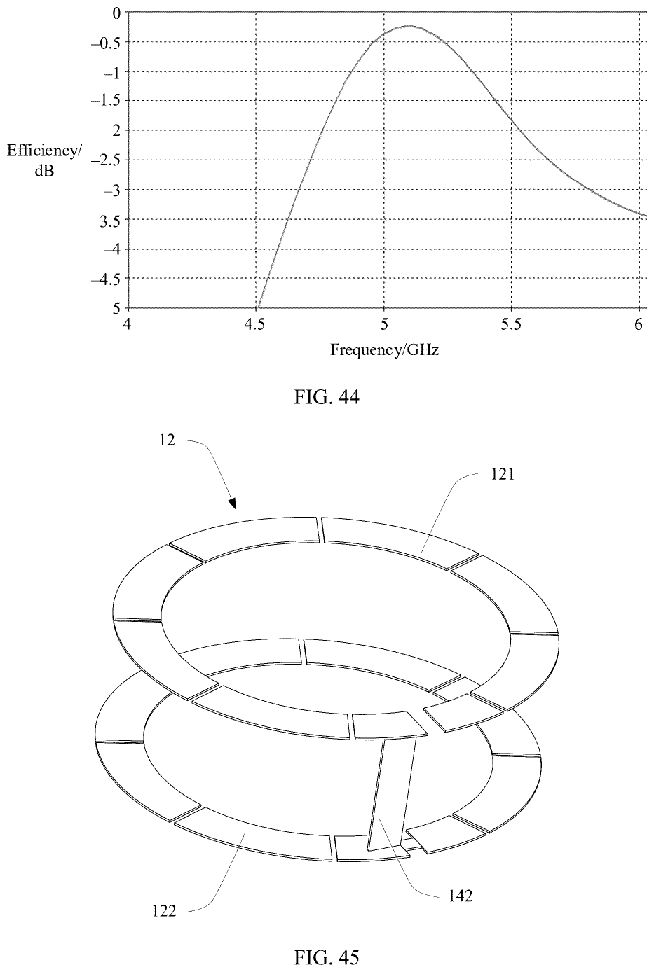

The antenna structure 12 in the foregoing embodiment may be configured to generate sixth resonance. As shown in FIG. 40, the feed point F may be located on a stub 142. In an embodiment, in the at least two stubs 142, any two adjacent stubs 142 may divide the first radiator 121 into a first section and a second section and may divide the second radiator 122 into a third section and a fourth section. A length of the second section in a circumferential direction of the first radiator 121 is greater than or equal to a length of the first section in the circumferential direction of the first radiator 121, and a length of the fourth section in a circumferential direction of the second radiator 122 is greater than or equal to a length of the third section in the circumferential direction of the second radiator 122. In a sixth resonance mode, the antenna structure 12 may be equivalently formed by connecting a plurality of antenna substructures. Each antenna substructure includes any two adjacent stubs 142, and a first section and a third section that are located between the any two adjacent stubs 142. FIG. 41 is a diagram of current distribution of the antenna structure 12 in FIG. 40 in the sixth resonance mode. As shown in FIG. 41, current distribution of the antenna structure 12 for generating the sixth resonance includes first co-directional current distribution on the any two adjacent stubs 142, first reverse current distribution on the first section, and second reverse current distribution on the third section, and the first reverse current distribution and the second reverse current distribution each have one current reverse point. In this case, the antenna structure 12 generates a fundamental mode f6 (f6 includes 5.9 GHz). FIG. 42 is a 3D pattern of the antenna structure in FIG. 40 in the sixth resonance mode. As shown in FIG. 42, when the antenna structure 12 is in the sixth resonance mode, a direction of a current on the first radiator 121 is opposite to a direction of a current on the second radiator 122, so that the current on the first radiator 121 and the current on the second radiator 122 can cancel each other. Therefore, the antenna structure 12 performs radiation in a vertical polarization manner through the at least two stubs 142. FIG. 43 is a diagram of S11 of the antenna structure in FIG. 40, and FIG. 44 is a diagram of efficiency of the antenna structure in FIG. 40. As shown in FIG. 43 and FIG. 44, the antenna structure 12 is equivalent to a plurality of antenna substructures operating together, to implement an omnidirectional radiation mode of the antenna structure 12, thereby implementing 360-degree horizontal-plane omnidirectional coverage of the electronic device 10. In addition, a node gain may be increased by 8 dB.

The electronic device 10 in the foregoing embodiment may be used in a vehicle. For example, in an embodiment, the electronic device 10 may be an in-vehicle infotainment system (e.g., telematics box (TBox)), and is configured to communicate with a plurality of electronic systems such as a mobile phone, a background system, or a base station, to display and control vehicle information. The electronic device 10 may be mounted in the vehicle, and may be located at the top of the vehicle, in a cabin, or in an engine compartment, to communicate with different electronic devices in any orientation inside the vehicle or different electronic devices in any orientation outside the vehicle. In this embodiment, the electronic device 10 may be integrated with another electronic device of the vehicle. In this case, the outer casing may be a fastening bracket of the antenna structure 12. Alternatively, the electronic device 10 may be an independent device. In this case, an outer surface of the outer casing may be an appearance surface of the electronic device 10. In another embodiment, the electronic device 10 may be a vehicle key, so that an operation performed by the vehicle key on the vehicle can be implemented at any orientation of the vehicle. In this embodiment, the outer casing may be an outer casing of the car key. During actual application of the electronic device 10 in this application, the outer casing may be a housing made of a non-metal material. Certainly, the outer casing may also be partially made of a metal material. This is not limited herein.

In an embodiment, in each antenna substructure, a sum of a length of the first section, a length of the third section, and lengths of the two stubs 142 is in a range of (0.8±0.25)λ, to further improve omnidirectional radiation performance of the antenna structure 12. In other words, a sum of a half of the length of the first section, a half of the length of the third section, and a length of a stub 142 connected between the first section and the third section is in a range of (0.4±0.125)λ. λ is a free space wavelength corresponding to a resonance point frequency of the sixth resonance.

During actual application, a shape of the antenna structure 12 may be set based on an application scenario. For example, as shown in FIG. 40, in an embodiment, a length of each stub 142 may be greater than the length of the first section, so that the shape of the antenna structure 12 is a slender shape. In this way, a width dimension of the antenna structure 12 may be reduced. FIG. 45 is a diagram of another structure of the antenna structure according to an embodiment of this application. As shown in FIG. 45, in another embodiment, a length of each stub 142 may alternatively be less than a length of a first section, so that a shape of the antenna structure 12 is a short and stout shape. In this way, a height dimension of the antenna structure 12 can be reduced.

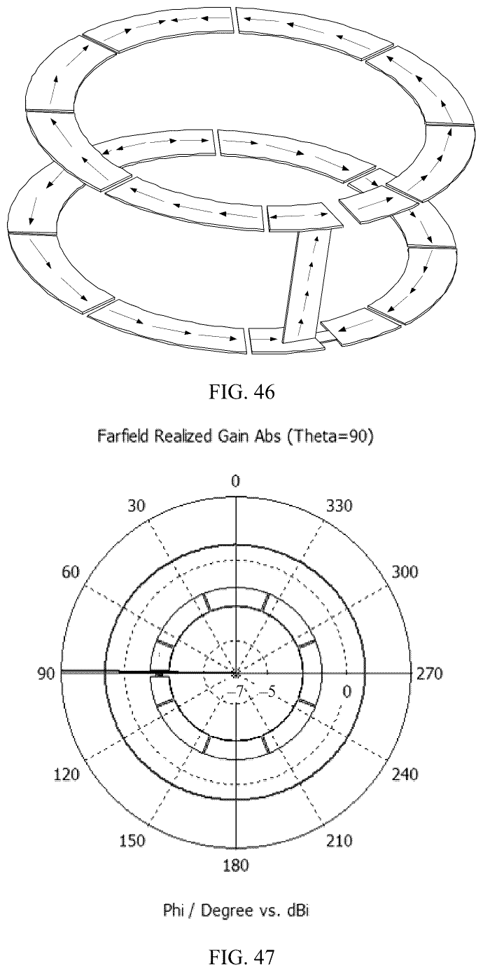

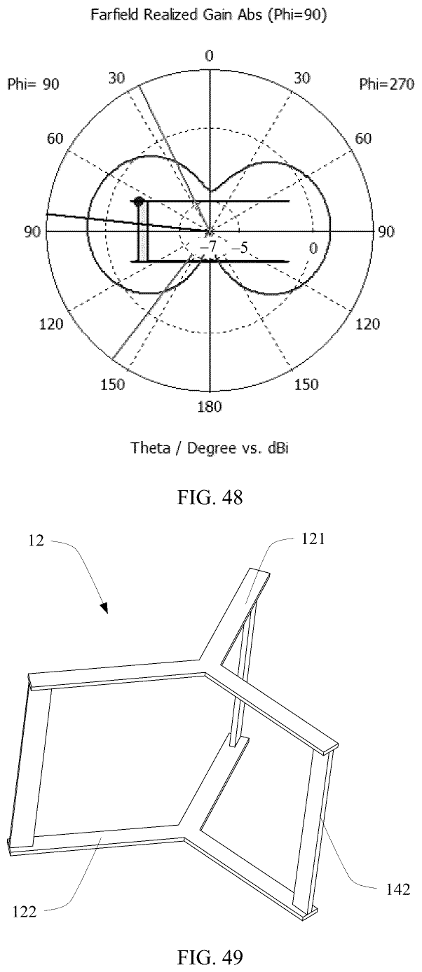

Still refer to FIG. 45. In the electronic device 10 in this application, a quantity of stubs 142 may alternatively be 1. FIG. 46 is a diagram of current distribution of the antenna structure in FIG. 45 in a sixth resonance mode, FIG. 47 is an E-plane pattern of the antenna structure in FIG. 45, and FIG. 48 is an H-plane pattern of the antenna structure in FIG. 45. As shown in FIG. 46, FIG. 47, and FIG. 48, when the quantity of stubs 142 is reduced to 1, a feed point F may be located on a first radiator 121 and disposed close to the stub 142. A current reverse point on the first radiator 121 may be located at a position opposite to the feed point F, and a current reverse point on a second radiator 122 may be located at a connection point between the stub 142 and the second radiator 122. In this way, in the sixth resonance mode, a current on the first radiator 121 and a current on the second radiator 122 may still cancel each other, and vertical polarization radiation is directly implemented. That is, the quantity of stubs 142 does not affect vertical polarization radiation of the antenna structure 12.

As shown in FIG. 40 and FIG. 45, between two adjacent stubs 142, the first radiator 121 may have a slot or a slit, and the slot or the slit of the first radiator 121 is located at a current reverse point of the first section. Similarly, the second radiator 122 may also have a slot or a slit, and the slot or the slit of the second radiator 122 is located at a current reverse point of the third section.

In the electronic device 10 of this application, the first radiator 121 and the second radiator 122 have a same shape. In an embodiment, the first radiator 121 and the second radiator 122 may be ring radiators, for example, the shape may include a triangle, a circle, a square, or another polygon. As shown in FIG. 40 and FIG. 45, in an embodiment, the first radiator 121 and the second radiator 122 are respectively radiation rings. The at least two stubs 142 are disposed at an equal distance in a circumferential direction of the radiation rings, and dimensions of the foregoing at least two stubs 142 are equal. Certainly, the first radiator 121 and the second radiator 122 may alternatively be in other shapes.

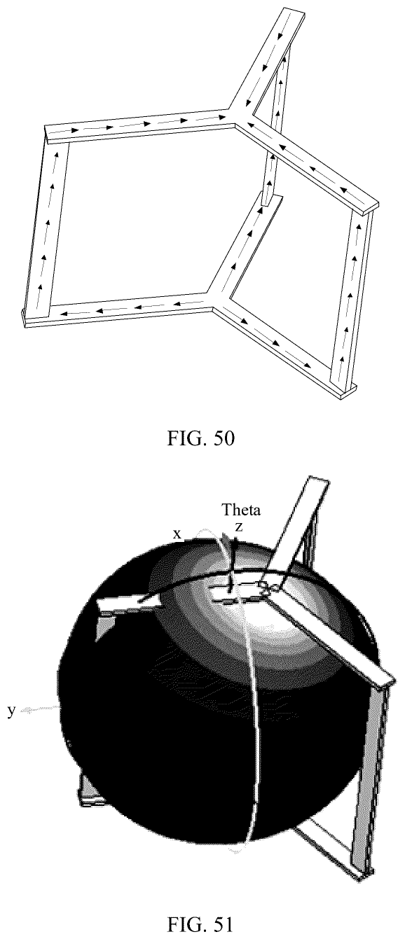

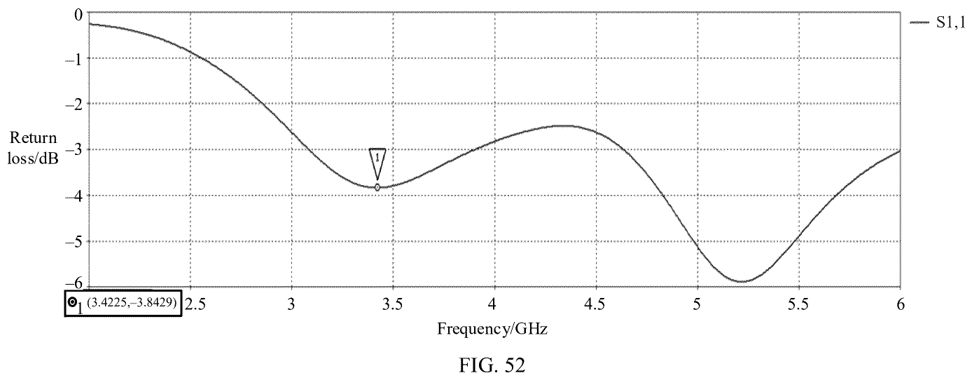

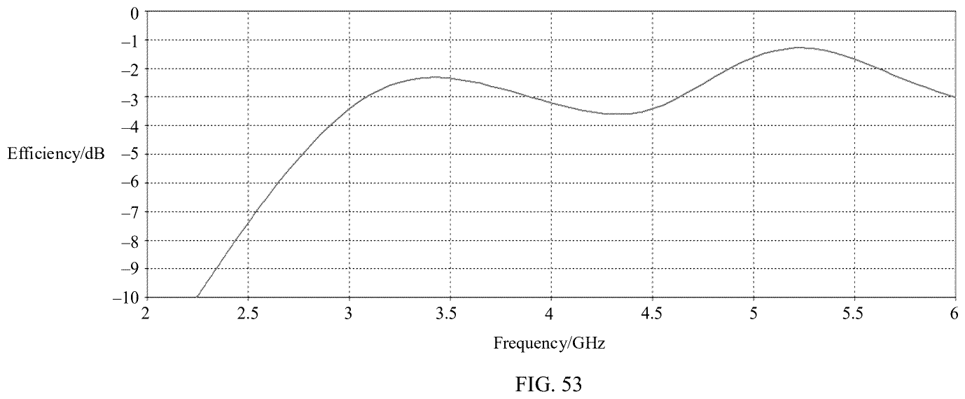

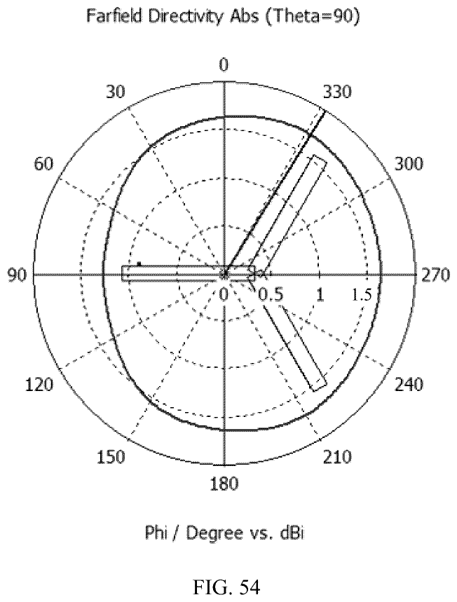

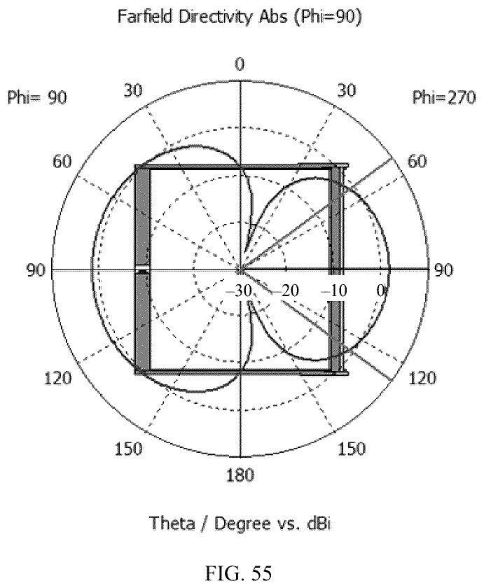

FIG. 49 is a diagram of another structure of the antenna structure according to an embodiment of this application. As shown in FIG. 49, in another embodiment, a first radiator 121 is used as an example. The first radiator 121 includes at least three radiation stubs. Ends of all of these radiation stubs are converged into one point and connected, the other ends of all of these radiation stubs extend in directions away from the point, and the other ends of these radiation stubs are arranged in an axial direction. In this embodiment, there is an equal included angle between any two adjacent radiation stubs. FIG. 50 is a diagram of current distribution of the antenna structure in FIG. 49 in a sixth resonance mode. As shown in FIG. 50, a current on the first radiator 121 flows from the other ends of the radiation stubs to the ends, and a current on a second radiator 122 flows from ends of the radiation stubs to the other ends. FIG. 51 is a 3D pattern of the antenna structure in FIG. 49 in the sixth resonance mode, FIG. 52 is a diagram of S11 of the antenna structure in FIG. 49, FIG. 53 is a diagram of efficiency of the antenna structure in FIG. 49, FIG. 54 is an E-plane pattern of the antenna structure in FIG. 49, and FIG. 55 is an H-plane pattern of the antenna structure in FIG. 49. As shown in FIG. 51 to FIG. 55, in the sixth resonance mode, the current on the first radiator 121 and the current on the second radiator 122 may still cancel each other, and vertical polarization radiation is directly implemented. Therefore, shapes of the first radiator 121 and the second radiator 122 do not affect vertical polarization radiation of the antenna structure 12 provided that the current on the first radiator 121 and the current on the second radiator 122 are reverse to implement cancellation of horizontal polarization currents.

The foregoing descriptions are merely embodiments of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. An electronic device, comprising:
an outer casing comprising a metal ring housing that extends in an axial direction; and
an antenna structure located in the outer casing and comprising a circuit board and a first radiation structure disposed on a side of the circuit board;
wherein:
the first radiation structure comprises a first radiation ring and a plurality of stubs, an axial direction of the first radiation ring is disposed at an included angle with the circuit board, the axial direction of the first radiation ring is parallel to the axial direction of the metal ring housing, the plurality of stubs are disposed between the first radiation ring and the circuit board in a circumferential direction of the first radiation ring and are electrically connected to the first radiation ring and the circuit board, the plurality of stubs comprise a feed stub and at least two first grounding stubs, the feed stub is electrically connected to a signal layer of the circuit board and is configured to feed the first radiation ring, and the at least two first grounding stubs are electrically connected to a grounding plane of the circuit board and are used for grounding; and
any two adjacent stubs of the plurality of stubs divide the first radiation ring into a first section and a second section, a length of the second section in the circumferential direction of the first radiation ring is greater than a length of the first section in the circumferential direction of the first radiation ring, the first radiation structure further comprises a plurality of first antenna substructures configured to generate a first resonance, and each first antenna substructure comprises two adjacent stubs and the first section of the first radiation ring is located between the two adjacent stubs.

2. The electronic device according to claim 1, wherein the first radiation ring is at a first distance from the circuit board and on a side of the circuit board that faces the first radiation structure, a second distance is between the circuit board and an end of the metal ring housing that is away from the circuit board, the second distance is greater than the first distance, the second distance is less than or equal to 0.22λ, and λ is a free space wavelength corresponding to a resonance point frequency of the first resonance.

3. The electronic device according to claim 1, wherein the first radiation ring comprises a plurality of first sections, lengths of the plurality of first sections in the circumferential direction of the first radiation ring are equal to one another, and dimensions of the plurality of stubs are equal to one another.

4. The electronic device according to claim 3, wherein a length of the first section is d1, lengths of the two adjacent stubs are respectively d2 and d3, and a sum of d1, d2, and d3 is in a range of (0.5±0.125)λ.

5. The electronic device according to claim 1, wherein current distribution of the first radiation structure for generating the first resonance comprises first co-directional current distribution on the two adjacent stubs and first reverse current distribution on the first section of the first radiation ring that is located between the two adjacent stubs, and the first reverse current distribution has a current reverse point.

6. The electronic device according to claim 4, wherein the first radiation ring has a slot or a slit between the two adjacent stubs, and the slot or the slit is located in a middle area of the first section.

7. The electronic device according to claim 1, wherein
the first radiation ring is configured to generate a second resonance, and a resonance point frequency of the second resonance is higher than a resonance point frequency of the first resonance; and
current distribution of the first radiation ring for generating the second resonance comprises second reverse current distribution on the first radiation ring, and the second reverse current distribution has two current reverse points.

8. The electronic device according to claim 7, wherein the first radiation ring is further configured to generate a third resonance, and a resonance point frequency of the third resonance is higher than the resonance point frequency of the second resonance; and
current distribution of the first radiation ring for generating the third resonance comprises third reverse current distribution on the first radiation ring, and the third reverse current distribution has four current reverse points.

9. The electronic device according to claim 2, wherein the antenna structure further comprises a second radiation structure that comprises a second radiation ring and at least two second grounding stubs, an axial direction of the second radiation ring is parallel to the axial direction of the first radiation ring, a minimum inner diameter of the second radiation ring is greater than a maximum outer diameter of the first radiation ring, and the at least two second grounding stubs are disposed between the second radiation ring and the circuit board in a circumferential direction of the second radiation ring and are electrically connected to the second radiation ring and the circuit board; and
any two adjacent second grounding stubs of the at least two second grounding stubs divide the second radiation ring into a third section and a fourth section, a length of the fourth section in the circumferential direction of the second radiation ring is greater than a length of the third section in the circumferential direction of the second radiation ring, the second radiation structure further comprises a plurality of second antenna substructures configured to generate a fourth resonance, and each second antenna substructure comprises two adjacent second grounding stubs and the third section of the second radiation ring is located between the two adjacent second grounding stubs.

10. The electronic device according to claim 9, wherein the second radiation ring comprises a plurality of third sections, lengths of the third sections in the circumferential direction of the second radiation ring are equal to one another, and dimensions of the at least two second grounding stubs are equal to one another.

11. The electronic device according to claim 9, wherein current distribution of the second radiation structure for generating the fourth resonance comprises second co-directional current distribution on the two adjacent second grounding stubs and fourth reverse current distribution on the third section of the second radiation ring that is located between the two adjacent second grounding stubs, and the fourth reverse current distribution has a current reverse point.

12. The electronic device according to claim 9, wherein the second radiation ring is at a third distance from the circuit board, and the third distance is greater than zero and less than the first distance.

13. The electronic device according to claim 1, wherein a fourth distance is between the first radiation ring and the metal ring housing in a circumferential direction of the metal ring housing, and the fourth distance is greater than or equal to 0.024λ.

14. An electronic device, comprising:
an outer casing; and
an antenna structure located in the outer casing and comprising a first radiator, a second radiator, and at least two stubs, wherein the first radiator and the second radiator are symmetrically disposed, and the at least two stubs are connected between the first radiator and the second radiator;
wherein:
the antenna structure further comprises a feed point located on one of the at least two stubs, or located on the first radiator and disposed close to one of the at least two stubs;
any two adjacent stubs of the at least two stubs divide the first radiator into a first section and a second section and divide the second radiator into a third section and a fourth section, a length of the second section in a circumferential direction of the first radiator is greater than or equal to a length of the first section in the circumferential direction of the first radiator, and a length of the fourth section in a circumferential direction of the second radiator is greater than or equal to a length of the third section in the circumferential direction of the second radiator; and
the antenna structure further comprises a plurality of antenna substructures configured to generate a sixth resonance, and each antenna substructure comprises any two adjacent stubs, and the first section and the third section are located between the any two adjacent stubs.

15. The electronic device according to claim 14, wherein
the electronic device is a telematics box (TBox), and is mounted in a vehicle; or
the electronic device is a vehicle key.

16. The electronic device according to claim 14, wherein for each antenna substructure, a sum of a length of the first section, a length of the third section, and lengths of the two adjacent stubs is in a range of (0.8±0.25)λ, and λ is a free space wavelength corresponding to a resonance point frequency of the sixth resonance.

17. The electronic device according to claim 14, wherein the first radiator and the second radiator are respectively radiation rings, the at least two stubs are disposed at an equal distance in a circumferential direction of the radiation rings, and dimensions of the at least two stubs are equal to one another.

18. The electronic device according to claim 16, wherein a length of each stub of the at least two stubs is greater than or less than the length of the first section.

19. The electronic device according to claim 14, wherein current distribution of the antenna structure for generating the sixth resonance comprises first co-directional current distribution on the any two adjacent stubs, first reverse current distribution on the first section, and second reverse current distribution on the third section, and each of the first reverse current distribution and the second reverse current distribution has a current reverse point.

20. The electronic device according to claim 19, wherein
the first radiator has a slot or a slit located at a current reverse point of the first section; or
the second radiator has a slot or a slit located at a current reverse point of the third section.
